(19) United States
(12) Patent Application Publication
(10) Pub. No.: US 2004/0064516 A1
(43) Pub. Date: Apr. 1, 2004

(54) Message information sharing apparatus and method

(75) Inventors: Sougo Tsuboi, Kanagawa-ken (JP); Hideo Umeki, Kanagawa-ken (JP)

Correspondence Address: Finnegan, Henderson, Farabow,, Garrett & Dunner, L.L.P., 1300 I Street, N.W., Washington, DC, 20005-3315, US

(73) Assignee: KABUSHIKI KAISHA

(21) Appl. No.: 10/653,580

(22) Filed: Sep. 3, 2003

(30) Foreign Application Priority Data
Aug. 29, 2002 (JP) P2002-250059
Aug. 27, 2003 (JP) 2003-303693

(51) Int. Cl. G06F 15/16

(52) U.S. Cl. 709/206; 709/214; 707/7

(57) ABSTRACT

A message receiving unit receives a message from a user. A message memory stores a plurality of messages each received by the message receiving unit. A set decision unit decides whether the received message is related to at least one message stored in the message memory. A set information memory stores a message set including the received message and the at least one message if the set decision unit decides that the received message is related to the at least one message. A set information edit unit edits a set relation among a plurality of message sets in response to the user's indication. The set information memory stores the set relation edited by the set information edit unit.

### CROSS-REFERENCE TO RELATED APPLICATIONS

This application is based upon and claims the benefit of priority from the prior Japanese Patent Application P2002-250059, filed on Aug. 29, 2002; the entire contents of which are incorporated herein by reference.

### FIELD OF THE INVENTION

The present invention relates to a message information sharing apparatus and a method for arranging messages sent by an electronic mail on a network such as an Internet or an Intranet.

### BACKGROUND OF THE INVENTION

As a means for users to mutually exchange information, an electronic mail (E-mail) is widely used. A discussion using the electronic mail is suitable for one-to-one communication. However, in the case of communication to which a plurality of users participate, a cost to maintain the discussion greatly increases because of follow-up of a participant and a dropout on halfway of the discussion and understanding of contents of the discussion on a large scale.

In order for a plurality of users to support the discussion using the electronic mail, a system called “mailing-list” is generally used. The mailing-list represents an alias address for mail addresses of a plurality of users. By sending an electronic mail to the alias address, the electronic mail is distributed to the mail address of each user. A system to create and maintain this mailing-list, and present various services for an electronic mail sent to the alias address, is called a “mailing-list support system (ML support system)”.

In the ML support system, there is not only a simple system to present the alias address only but also a high system including a memory means to store the message. In the high system using WWW (World Wide Web), an inspection function that looks and retrieves messages already sent to the alias address, a presentation function of a number of received messages per a unit time and a creation function of a digest of contents of the received messages, are included. Furthermore, by preparing a mail delivering function in a WWW electronic bulletin board, there are many systems which actually function as the ML support system.

However, use of the mailing-list is limited to the case that a companion and a topic are previously determined at a timing of start of the discussion, and the case that a scale and a term of the discussion should be relatively large. Some communications may be executed by using not the mailing-list but a normal electronic mail. This may be because creation of the mailing-list is troublesome for the user and the user cannot decide whether the discussion will become a large scale discussion using the mailing-list at a start timing of the discussion.

In the case that the discussion becomes active without using the mailing-list, the following two problems occur. First, it is very difficult to manage a plurality of mails as a set on a predetermined topic. Second, if a scale of the discussion becomes large and the user wishes to shift the discussion to the mailing-list, it is very difficult to take in details of the discussion of the past.

The first problem occurs in the case that the same topic is inquired of various persons or discussed among various persons. Recently, many mail clients prepare a grouping function of mails. However, basically, grouping of mails sent to predetermined mail address, or a grouping of mails including predetermined characters, are only possible. Even if grouping of mails is personally executed by above-mentioned function, a participant joining in late on the discussion cannot refer to former contents of the discussion. Furthermore, a dropout on halfway of the discussion cannot know later details of the discussion. Accordingly, this grouping function cannot solve the first problem.

The second problem occurs in the case that the discussion becomes active and a user wishes to use the ML support system. It is difficult that the past contents of the discussion with attributes, such as a sender name and a sending date, are taken in the ML support system. Furthermore, selection of a person as a participant of the mailing list is a troublesome problem.

By these problems, it is difficult to use the mailing-list at a start timing of discussion, and it is also difficult to continue the discussion without using the mailing-list. Furthermore, it is difficult to shift mails given and taken to the mailing-list on halfway of the discussion. In the prior art, attempts have been made to approach the above-mentioned problem.

As one example, a QUICK-ML system to simplify creation and a participation method of mailing-list is disclosed in a prior art article (UNIX Magazine 2002/5 Vol.17 #5, P110˜117 “Ohchaku-Programing 5: QuickML” Satoru Takabayashi)

In this system, a suitable “xxxx” such as “xxxx@guickml.com” is indicated as an address and participants of the mailing-list are indicated as a copy “(CC:)”. If the address “xxxx” is not used yet, the mailing-list “xxxx@quickml.com” is automatically created. In the case of addition of a new participant, the new participant can be added by writing an address of this participant to a copy “(CC:) “. However, in this system, users need to create a mailing-list before communication. In other words, users cannot shift mails given and taken in the past to the mailing-list.

As another example of the prior art, a system to define a group relation of participants among a plurality of mailing-lists, and to collectively execute distribution of the mail, addition and deletion of the participant, is disclosed in Japanese Patent (Kokai) PH09-218832. However, in this system, users must manually creat the mailing-list, and a set relation among a plurality of mails is not defined.

### SUMMARY OF THE INVENTION

The present invention is directed to a message information sharing apparatus and a method for automatically grouping a plurality of messages for each topic in order for senders to create a mailing-list.

According to an aspect of the present invention, there is provided a message information sharing apparatus, comprising: a message receiving unit configured to receive a message from a user; a message memory configured to store a plurality of messages each received by said message receiving unit; a set decision unit configured to decide whether the message received by said message receiving unit is related to at least one message stored in said message memory; a set information memory configured to store a message set including the received message and the at least one message if said set decision unit decides that the received message is related to the at least one message; and a set information edit unit configured to edit a set relation among a plurality of message sets in response to the user's indication; wherein said set information memory stores the set relation edited by said set information edit unit.

According to other aspect of the present invention, there is also provided a method for sharing message information, comprising: receiving a message from a user; storing a plurality of messages each received in a message memory; deciding whether the received message is related to at least one message stored in the message memory; storing a message set including the received message and the at least one message in a set information memory if the received message is related to the at least one message; editing a set relation among a plurality of message sets in response to the user's indication; and storing the set relation edited in the set information memory.

According to still other aspect of the present invention, there is also provided a computer program product, comprising: a computer readable program code embodiment in said product for causing a computer to share message information, said computer readable program code comprising: a first program code to receive a message from a user; a second program code to store a plurality of messages each received in a message memory; a third program code to decide whether the received massage is related to at least one message stored in the message memory; a fourth program code to store a message set including the received message and the at least one message in a set information memory if the received message is related to the at least one massage; a fifth program code to edit a set relation among a plurality of message sets in response to the user's indication; and a sixth program code to store the set relation edited in the set information memory.

### BRIEF DESCRIPTION OF THE DRAWINGS

FIG. 1 is a block diagram of all components of a message information sharing system according to an embodiment of the present invention.

FIG. 2 is a block diagram of a basic component of the message information sharing system according to a first embodiment of the present invention.

FIG. 3 is a block diagram of a basic component of the message information sharing system according to a second embodiment of the present invention.

FIG. 4 is a block diagram of a basic component of the message information sharing system according to a third embodiment of the present invention.

FIG. 5 is a schematic diagram of one example of user information stored in a user information memory 206 of FIG. 2.

FIGS. 6A, 6B, 6C, 6D, 6E and 6F are schematic diagrams of example messages stored in a message memory 203 of FIG. 2.

FIG. 7 is a schematic diagram of one example of a data structure for a message stored in a message memory 203 of FIG. 2.

FIG. 8 is a schematic diagram of a relation between each message and each user.

FIG. 9 is a schematic diagram of one example of message set information stored in a set information memory 205 of FIG. 2.

FIG. 10 is a schematic diagram of one example of a set relation stored in the set information memory 205 of FIG. 2.

FIG. 11 is a schematic diagram of one example of alias address information stored in the set information memory 205 if FIG. 3.

FIGS. 12A, 12B and 12C are schematic diagrams of example related information stored in a related information memory 413 of FIG. 4.

FIG. 13 is a flow chart of processing from a message receiving to a message sending in the message information sharing system according to one embodiment of the present invention.

FIG. 14 is a flow chart of processing of editing information in the message information sharing system according to one embodiment of the present invention.

FIG. 15 is a schematic diagram of one example of a message set display screen according to one embodiment of the present invention.

FIG. 16 is a schematic diagram of one example of a set relation edit screen according to one embodiment of the present invention.

FIG. 17 is a schematic diagram of one example of a set relation display screen according to one embodiment of the present invention.

FIG. 18 is a schematic diagram of one example of an alias address edit screen according to one embodiment of the present invention.

FIG. 19 is a schematic diagram of one example of an alias address display screen according to one embodiment of the present invention.

FIG. 20 is a schematic diagram of one example of a detail screen of an alias address display and edit according to one embodiment of the present invention.

FIG. 21 is a schematic diagram of an application example for a general mailer according to one embodiment of the present invention.

FIG. 22 is a block diagram of a basic component of the message information sharing system according to a fourth embodiment of the present invention.

FIG. 23 is a flow chart of processing of external message input and disclosure condition edit in the message information sharing system according to the fourth embodiment of the present invention.

FIG. 24 is a schematic diagram of one example of an input screen of external message according to one embodiment of the present invention.

FIGS. 25A, 25B and 25C are schematic diagrams of examples of external messages.

FIG. 26 is a schematic diagram of one example of a data structure including the external messages stored in the message memory 203 of FIG. 22.

FIG. 27 is a schematic diagram of one example of message set information including the external messages stored in the set information memory 205 of FIG. 22.

FIG. 28 is a schematic diagram of one example of an indication screen of disclosure condition according to one embodiment of the present invention.

FIG. 29 is a schematic diagram of one example of a data structure stored in a message disclosure condition memory 2203 of FIG. 22.

FIG. 30 is a flow chart of processing of a message filter unit 2204 of FIG. 22 according to the fourth embodiment of the present invention.

FIG. 31 is a schematic diagram of one example of a message list screen including the rewritten message according to one embodiment of the present invention.

### DETAILED DESCRIPTION OF THE EMBODIMENTS

Hereinafter, various embodiments of the present invention will be explained by referring to the drawings.

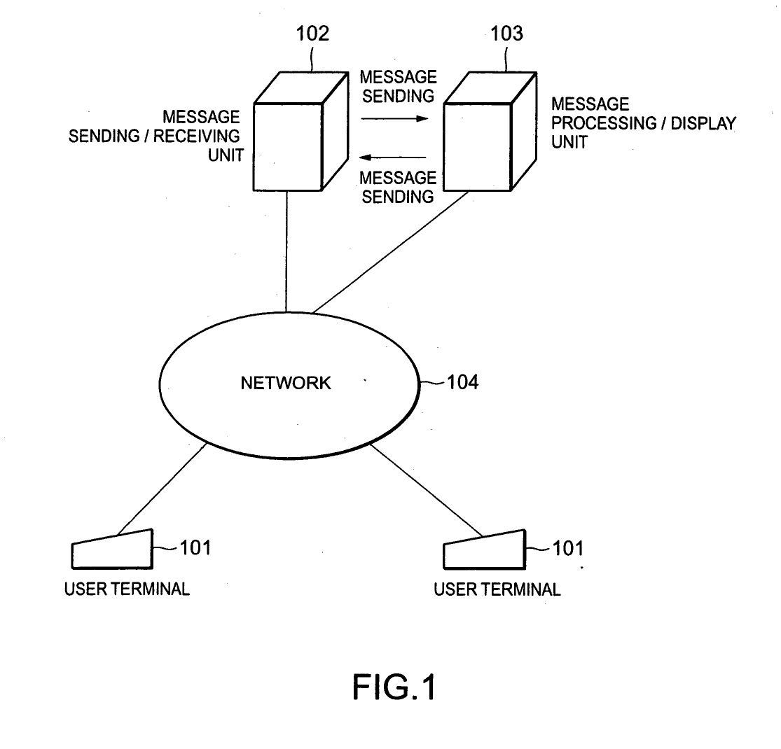

FIG. 1 is a block diagram of all components of a message information sharing system according to one embodiment of the present information. In this embodiment, a user accesses the message information sharing system through a network 104, such as the Internet or an Intranet, by using a user terminal 101 such as a WEB browser or a mailer. This system includes a message sending/receiving unit 102 and a message processing/display unit 103 which mutually exchange a message. These two units are basically located on the same host. However, these two units may be dispersedly located on a plurality of hosts because the former unit 102 can be replaced by a known mail server.

As used herein, those skilled in the art will understand that the term “unit” is broadly defined as a processing device (such as a server, a computer, a microprocessor, a specially programmed logic circuit, an application specific integrated circuit, a discrete circuit, etc.) that provides the described communication and functionality desired. While such a hardware-based implementation is clearly described and contemplated, those skilled in the art will quickly recognize that a “unit” may alternatively be implemented as a software module that works in combination with such a processing device.

Depending on the implementation constraints, such a software module or processing device may be used to implement more than one “unit” as disclosed and described herein. Those skilled in the art will be familiar with particular and conventional hardware suitable for use when implementing an embodiment of the present invention with a computer or other processing device. Likewise, those skilled in the art will be familiar with the availability of different kinds of software and programming approaches suitable for implementing one or more “units” as one or more software modules.

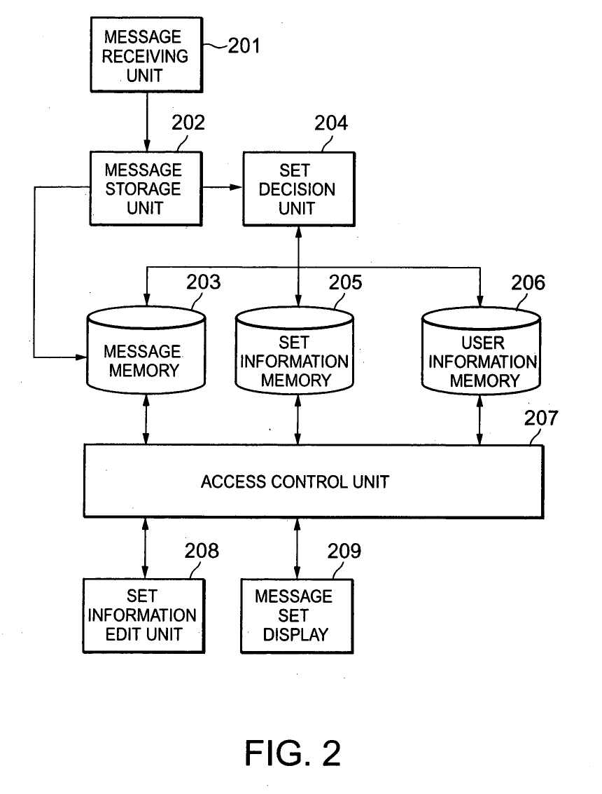

Hereafter, internal processing of the message sending/receiving unit 102 and the message processing/display unit 103 are explained in detail. FIG. 2 is a block diagram of the smallest component of the message information sharing system according to the present embodiment. In FIG. 2, a message receiving unit 201 receives a message sent to this system as a destination. The message receiving unit 201 has at least one receivable message address, receives a message sent to the message address, and stores the message in a message storage unit 202. In the following explanation, assume that the message receiving unit 201 has a plurality of message addresses each including “@ms.tosh.co.jp” at the end. This message receiving unit can be replaced by a known mail server.

The message storage unit 202 records contents of the message in a message memory 203, and activates a set decision unit 204. The set decision unit 204 decides a relation between the received message and existing message set already received. After deciding the relation, the set decision unit 204 defines a new set for the received message or links the received message as a part of existing message set with any message set. These contents (definition of new set or update of existing message set) are recorded in a set information memory 205. Furthermore, names of a sender and a recipient are compared with contents of a user information memory 206, and a name of unregistered user is registered in the user information memory 206.

Hereafter, a processing function in the case of accessing the recorded message by the user terminal 101 is explained. When a user begins to access the recorded messages, an access control unit 207 decides whether the user has the right to operate this system or to inspect messages to be displayed by referring to information stored in the set information memory 205 or the user information memory 206. A message set display 209 displays the message stored in the message memory 203 as a single unit or as the message set related by the set information memory 205. A set information edit unit 208 edits the contents of the set information memory 205 through the access control unit 207, and executes processing (such as creating a new definition of the relation between message sets or an addition of a new message set to the existing set relation).

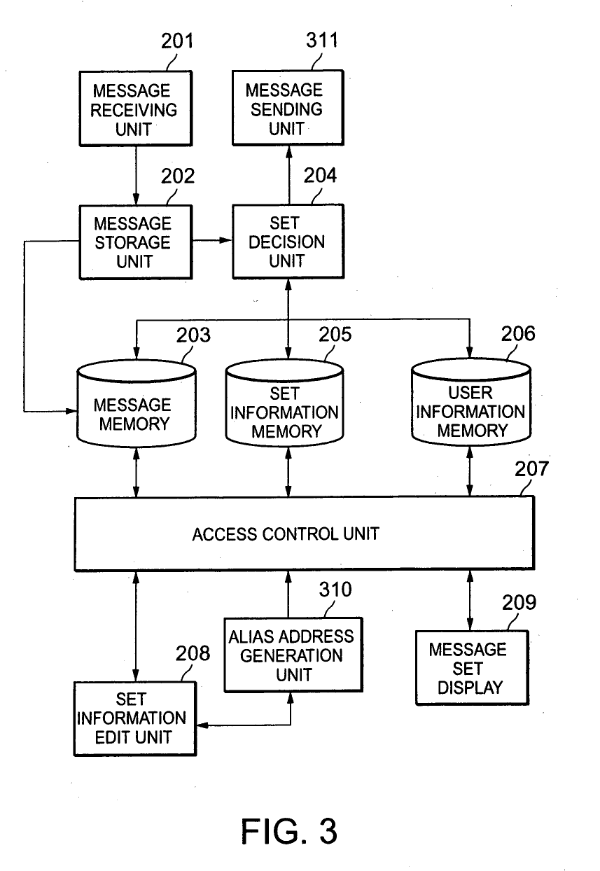

FIG. 3 is a block diagram of a basic component of the message information sharing apparatus to which a generation processing of mail alias is added according to one embodiment of the present invention. In comparison with the block diagram of FIG. 2, an alias address generation unit 310 and a message sending unit 311 are further added. Each function unit (201˜209) in FIG. 3 are the same as each function unit (201˜209) of FIG. 2. However, several units include additional function as follows.

The set information edit unit 208 executes a new creation and an edit processing of alias address for the relation between message sets, and activates the alias address generation unit 310. Furthermore, the set information edit unit 208 executes processing of relating a plurality of users with the alias address.

The alias address generation unit 310 records a correspondence between the alias address and the set relation, and a correspondence between the alias address and a user. If a destination of the received message is the alias address, the set decision unit 204 adds a set to which the received message belongs to a set relation corresponding to the alias address. Furthermore, if related users corresponding to the alias address are recorded, the set decision unit 204 activates the message sending unit 311 by supplying information of the related users. The message sending unit 311 sends the message to each of the related users supplied by the set decision unit 204. The message sending unit 311 and the message receiving unit 201 can be generally replaced by a known mail server.

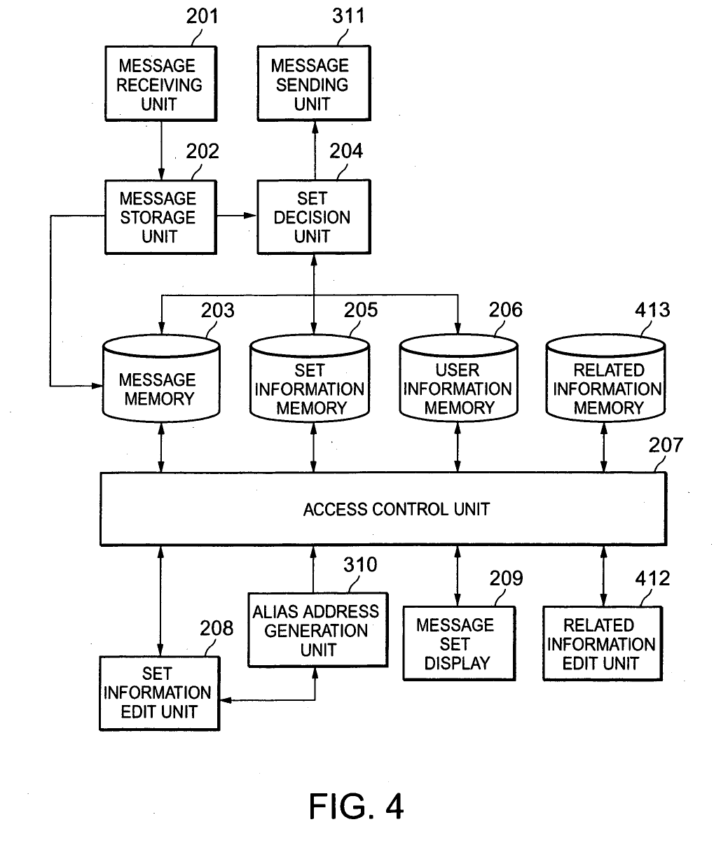

FIG. 4 is a block diagram of a basic component of the message information sharing apparatus which processes related information according to one embodiment of the present invention. In comparison with FIG. 3, a related information edit unit 412 and a related information memory 413 are included. Each unit (210˜411) of FIG. 4 are the same as each unit (201˜311) of FIG. 3. However, several units include additional functions as follows.

The related information memory 413 stores an information resource related to a message set or a set relation recorded in the set information memory 205. The related information edit unit 412 adds or edits the information resource related to the message set or the set relation recorded in the set information memory 205.

The message set display 209 extracts related information linked with a message set or a set relation to be displayed from the related information memory 413, and displays the related information with the message set or the set relation. Hereafter, flow and effect of the processing are explained based on component of FIG. 4 including all units.

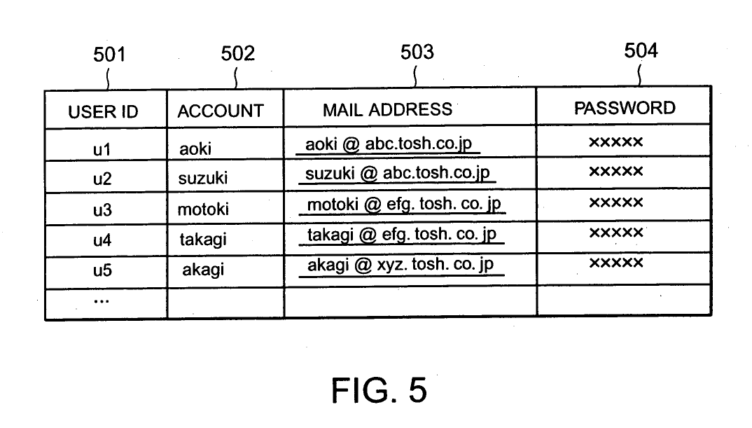

FIG. 5 is a schematic diagram of one example of user information stored in the user information memory 206. As shown in FIG. 5, each user is identified by a unique user ID 501. Items of an account 502, a mail address 503 and a password 504 of each user, are stored and managed. A plurality of mail addresses can be defined for one user ID. User information is automatically created by the set decision unit 204, but may be explicitly created. The password can be an empty value. In this case, the password is always “NO (false)” for user confirmation (explained afterwards).

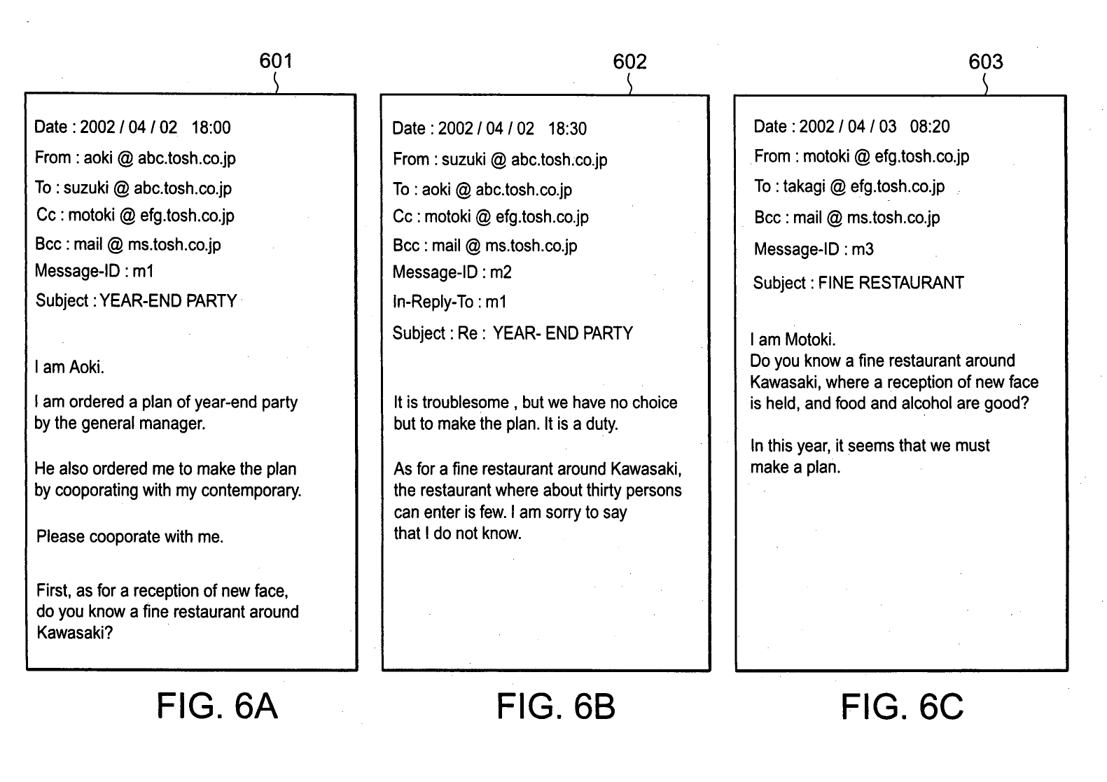

FIGS. 6A-6F are schematic diagrams of examples of messages received by the message receiving unit 201 and stored in the message memory 203 through the message storage unit 202. FIG. 6A shows a new message 601 created by a user “aoki (aoki@abc.tosh.co.jp)”. FIG. 6B shows a reply message 602 of a user “suzuki” for the message 601. FIG. 6C shows a message 603 of a user “motoki” to a user “takagi” in response to the message 601. The message 603 is not a reply for the message 601, and is regarded as a new message. FIG. 6D shows a reply message 604 of the user “takagi” for the message 603 of the user “motoki”. FIG. 6E shows a new message 605 of the user “motoki” sent to all related persons in response to the message 604. FIG. 6F shows a new message 606 of the user “aoki” sent to a user “akagi” as another topic. In this exemplary embodiment, these messages are based on RFC822 determined by IETF (Internet Engineering Task Force), and consists of header information (a sender (From:), a destination (To:, CC:, BCC:), a sending date (Date:), a subject (Subject;)) and the text. Furthermore, in this example, an identifier peculiar to the message (Message-ID header) is used. In the case where this identifier does not exist, by combining the sending date with the sender information, a peculiar identifier may be approximately created and substituted.

Furthermore, in this example, an identifier (In-Reply-To header) representing a reply relation between messages is used. In the case where this identifier does not exist, by inferring a relation between messages contributed in the past from sentence contents surrounded by quotation marks (”>” or “|”) in the text, a reply relation may be defined. In this example, Message-ID header and In-Reply-To header are widely used in general and not special identifiers.

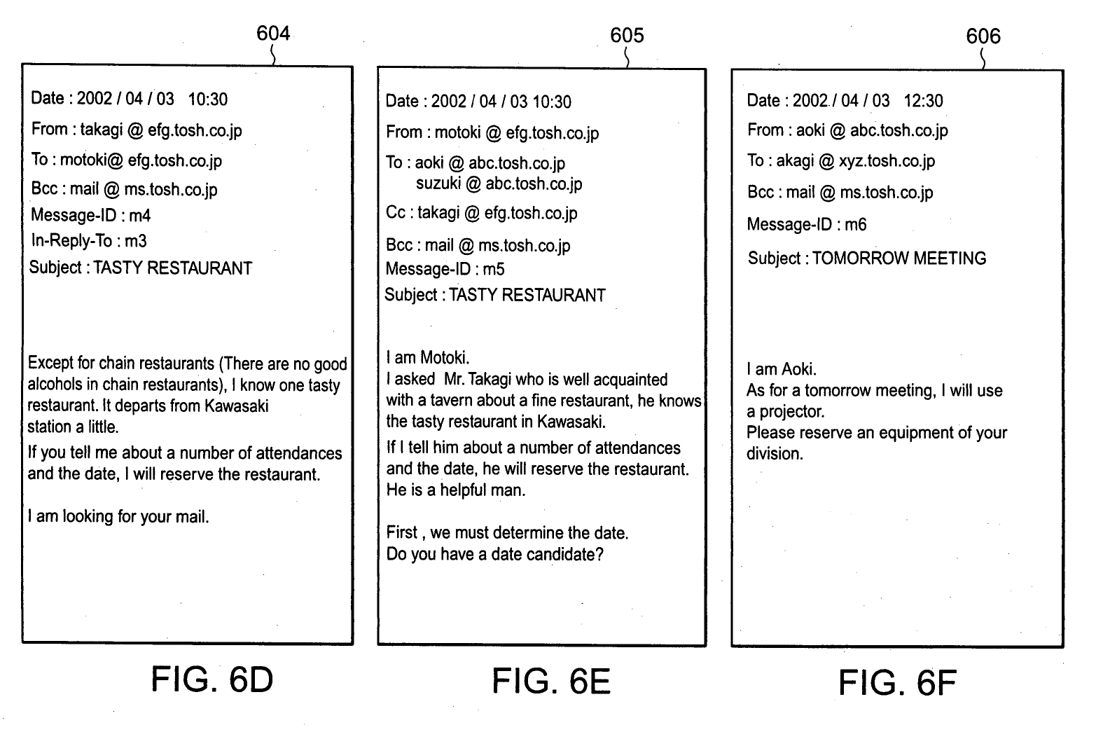

FIG. 7 is a schematic diagram of one example of a data structure for the messages of FIGS. 6A˜6F in the message memory 203. The data structure is consisted of fields for a message ID 701, a sending date 702, a subject 703, a sender 704, a destination 705, a parent ID 706, and contents 707. The message ID is a peculiar identifier to discriminate the message. “Message-ID” header in the message may be used as it is. The parent ID represents a reply relation between messages, and a reply message can include one or a plurality of parent IDs, Information of “In-Reply-To” header in the message may be used as the parent ID. Otherwise, by inferring a relation between messages contributed in the past from sentence contents surrounded by quotation marks (“>” or “|”) in the text, or by deciding a similarity of contribution time and destination or a similarity of sentences from static quantity of each word appeared in the text, a previous message in time series may be recorded as a parent message.

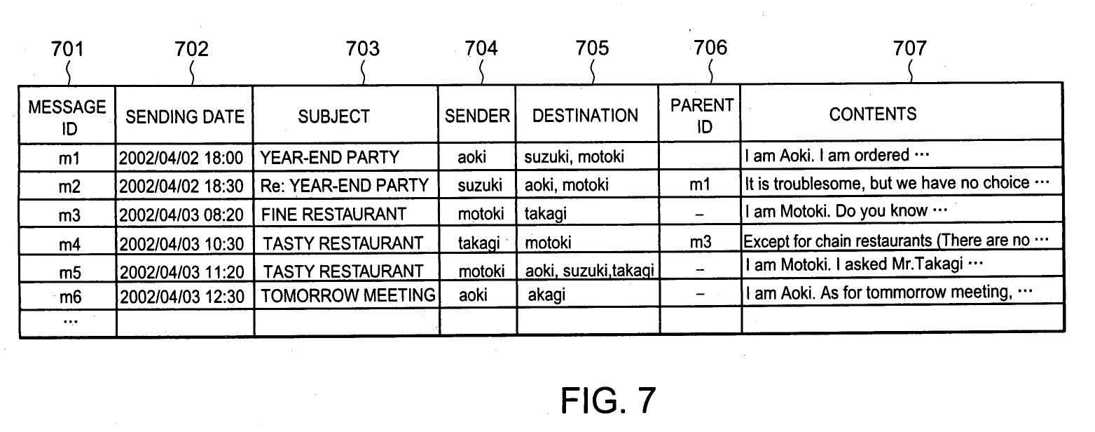

FIG. 8 is a schematic diagram of relation between each user and each message stored in FIGS. 6 and 7. The message ID is arranged along a vertical axis 801 and the user name is arranged along a horizontal axis 802. By classifying messages using a reply relation, these messages are classified into four sets (m1, m2), (m3, m4), (m5) and (m6). For example, a user “aoki” relates to three message sets (m1, m2), (m5) and (m6). This relation may be guided from a relation between the message and the user stored in the message memory 203. Otherwise, this relation may be stored in the message memory 203.

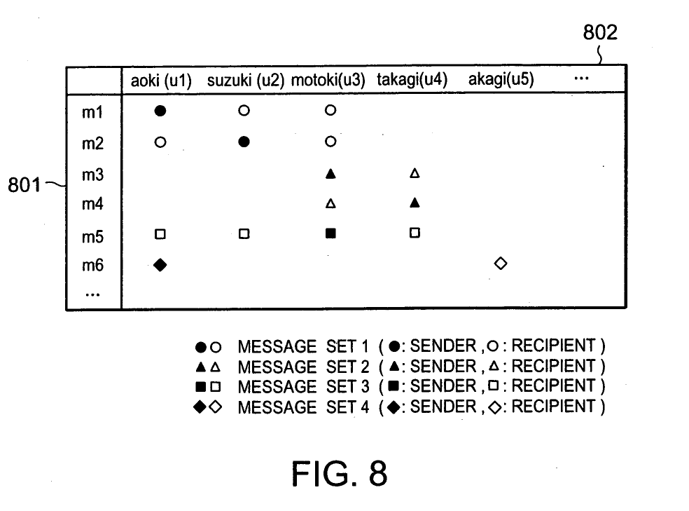

FIG. 9 is a schematic diagram of one example of message set information recorded in the set information memory 205. The message set information is consisted of a message set ID 901 as an identifier peculiar to the message set, a message ID included in the message set, and user name 903 related to messages of the message set. FIG. 9 represents one expression based on contents of FIG. 8. IDs “t1˜t4” are respectively assigned to four message sets. This message set information can be mechanically created from information of FIG. 7. However, as the related users except for the sender and the destination of the message, a user (For example, the name is described) related to contents of the message may be registered as a related user.

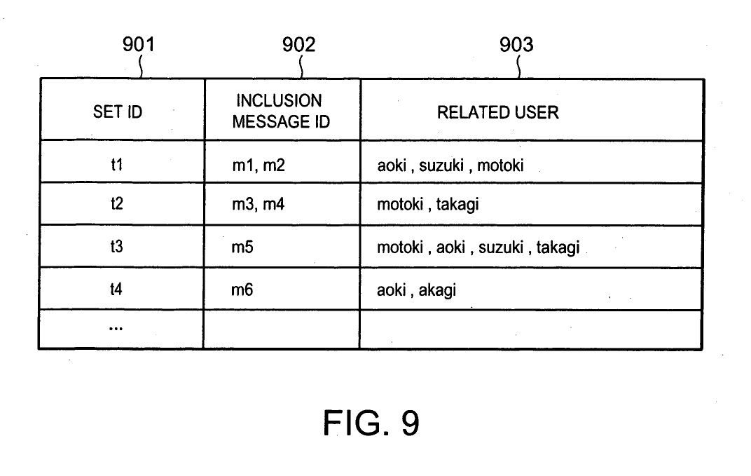

FIG. 10 is a schematic diagram of one example of a relation (hereafter, it is called a set relation) between message sets recorded in the set information memory 205. The set relation is created by the user's operation through the set information edit unit 208. The set relation is consisted of a set relation ID 1001, a message set ID 1002 of message sets included in the set relation, and a user ID 1003 of a user who created this relation.

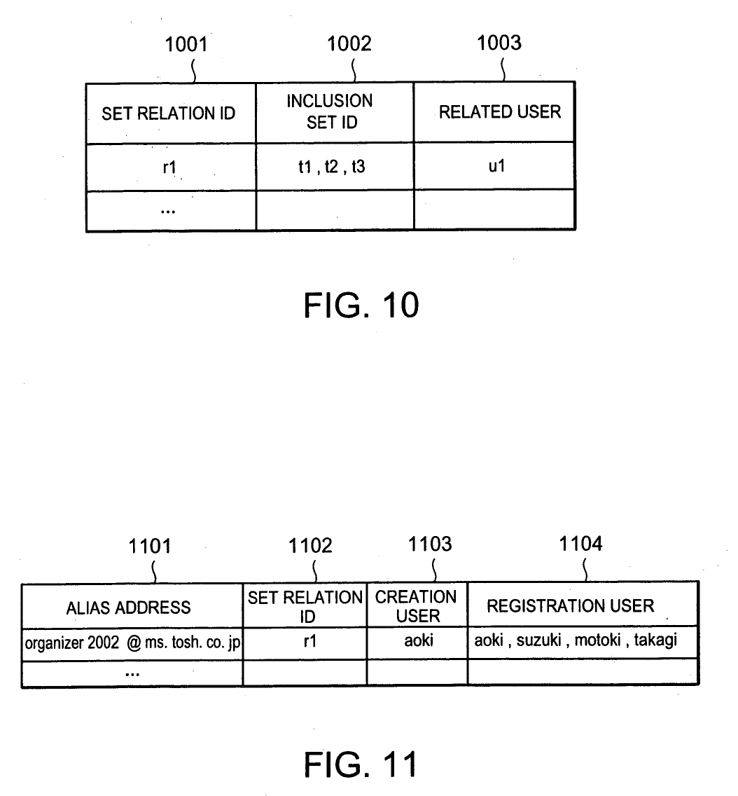

FIG. 11 is a schematic diagram of one example of alias address information stored in the set information memory 205. This information is consisted of an alias address 1101, a set relation ID 1102 of a set relation corresponding to this alias address, a user ID 1103 of a user who created this alias address, and user IDs 1104 registered to this alias address. This information related to the alias address is created and stored by the set information edit unit 208 and the alias address generation unit 310. The alias address 1101 is a main key of this table. A message address which is different from another message address and receivable for the message receiving unit 201 is written as the alias address 1101. The set relation ID 1102 represents a set relation corresponding to this alias address. A message set to which the message sent to this alias address belongs is decided to be included in this set relation ID.

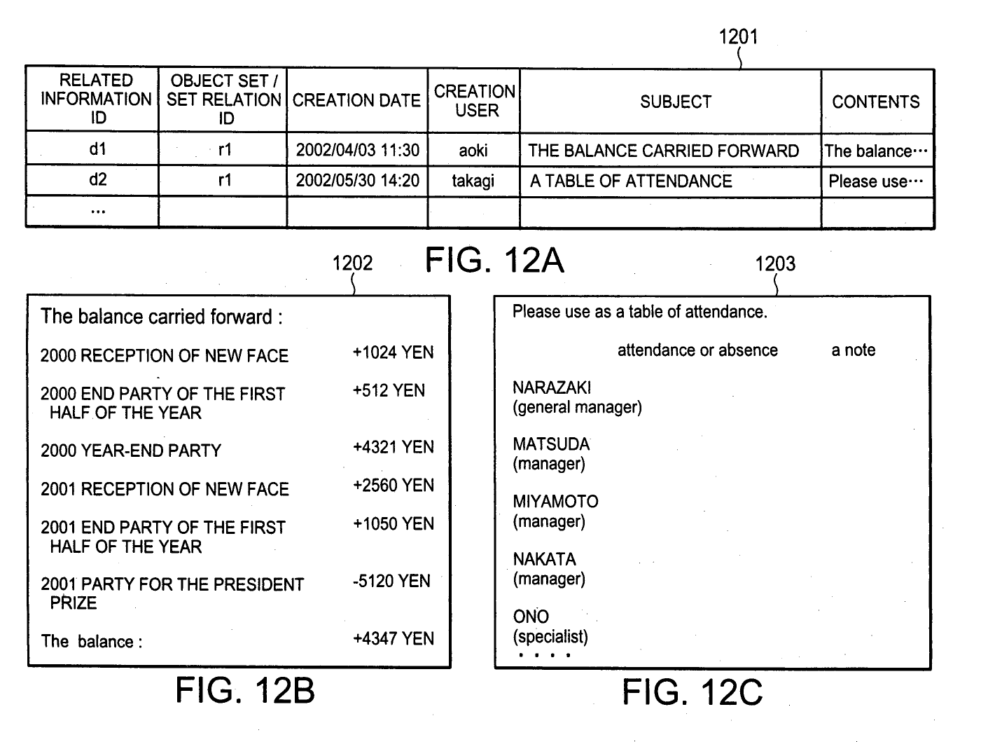

FIGS. 12A, 12B and 12C are schematic diagrams of example information related to a set relation stored in the related information memory 413. FIG. 12A shows a table 1201 representing a correspondence between the related information and the set relation. FIGS. 12B and 12C show examples of the related information. When the message set display 209 displays the set relation “r1”, the related information is additionally displayed and used as reference information of a topic or a reusable material. The related information is created using the related information edit unit 412 by the user. However, by using various methods of a community system or a mailing system, a digest of the message set, a document summarizing a description based on predetermined rule, or a document mentioning meta information (contribution frequency or total quantity of contribution) of the message set, may be created by the system. This document may be registered and updated as the related information at the time of generation or change of the message set.

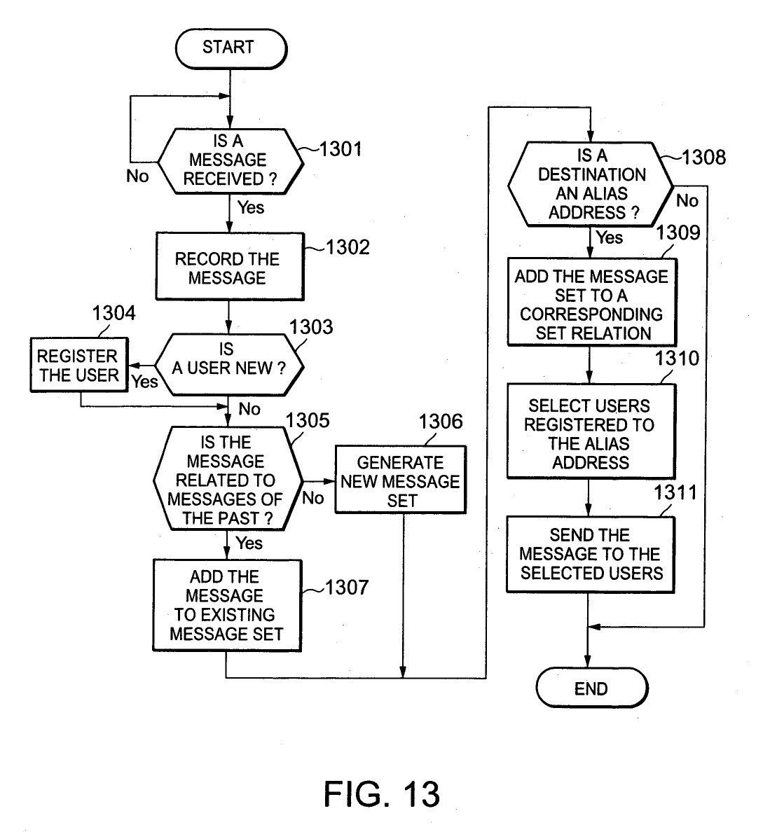

FIG. 13 is a flow chart of processing of a message receiving, a message recording, a set decision and a message sending according to one embodiment of the present invention. Hereafter, a processing in the case of receiving a message is explained. First, the system waits until a message is received (step 1301). When the message receiving unit 201 receives a message, the message storage unit 201 records the message in the message memory 203 (step 1302). Next, if at least one of a sender and a recipient (destination) of the message is not registered in the user information memory 206 (step 1303), this new user is registered in the user information memory 206 (step 1304). In the case of user registration, the account 502 and the password 504 are automatically created from mail address and so on. These contents may be informed to a user registered in the user information memory 206. Otherwise, the password 504 is set to a user who may be permitted to use the message set display 209 by a system message, and an “empty” value as the password may be set to other users. In either case, since then, the existence of user information corresponding to a mail address in a message received by the system is assured.

Next, the set decision unit 204 decides whether the received message is related to messages recorded in the past (step 1305). If the received message is related to at least one of the recorded messages, the received message is added to a message set including the at least one recorded message (step 1307). If the received message is not related to each of the recorded messages, a new message set including the received message is created (step 1306). A reply relation between messages can be decided by above-mentioned methods.

Next, it is decided whether a destination of the received message is an alias address corresponding to a set relation stored in the set information memory 205 (step 1308). If the destination of the received message is the alias address, the message set including the received message is added to the set relation corresponding to the alias address (step 1309). In this case, if the message set including the received message is already included in the set relation, this addition processing is not executed. Next, if registered users corresponding to the alias address are stored in the set information memory, the message sending unit 311 sends the received message to each of the registered users (step 1310, step 1311).

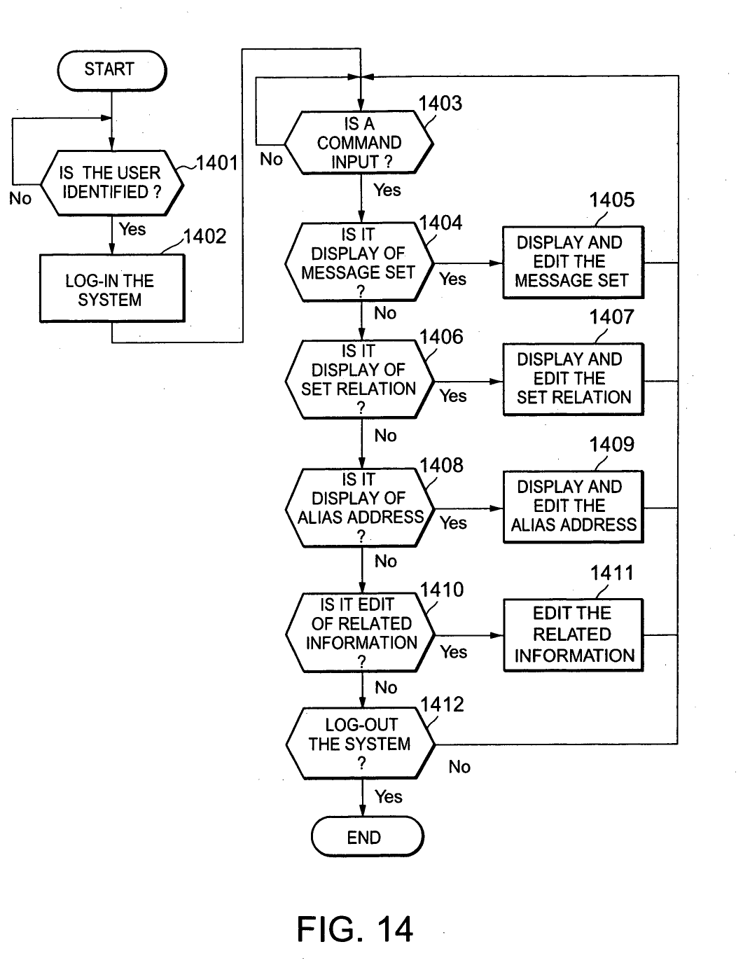

FIG. 14 is a flow chart of processing of inspection and edit of information stored in the system in the case that a user accesses the system from the user terminal 101 through the network 104. Hereafter, an interaction between the system and the user, and an internal processing, are explained by referring to FIG. 14.

First, a user who wishes to use the system is identified by the access control unit 207 (step 1401). As for the user registered by the system, the system becomes under condition of log-in (step 1402). Hereafter, this user can inspect and edit information stored in the system. Except for an identification using the account and the password, user identification may be executed by a combination of “Message-ID” of the received message and the user's mail address. Briefly, the user identification may be executed by a combination of information stored in the user information memory 206 and information known by the user only.

Mainly, the user's inspectional information represents message information belongs to the set relation and the message set related to the user. There are various selection items for whether a user related to the message set can inspect all messages included in the message set by neglecting whether the user directly receives the message. This detailed condition may be optional. In the following explanation, assume that a user related to the message set can inspect all messages belonging to the message set.

As for the user who is under a condition of system log-in, the processing remains waiting for a command input (step 1403). The user selectively inputs a display command of message set (step 1404), a display command of set relation (step 1406), a display command of alias address (step 1408), an edit command of related information (step 1410), or a log-out command of use completion of the system (step 1412). After the user's command is input, a processing corresponding to the command is executed (steps 1405, 1407, 1409, 1411), and the processing is returned to the wait status of command input (step 1403). The display contents and selection item of the above-mentioned command change based on the command previously input. Hereafter, a processing and a display example after selecting each command is explained.

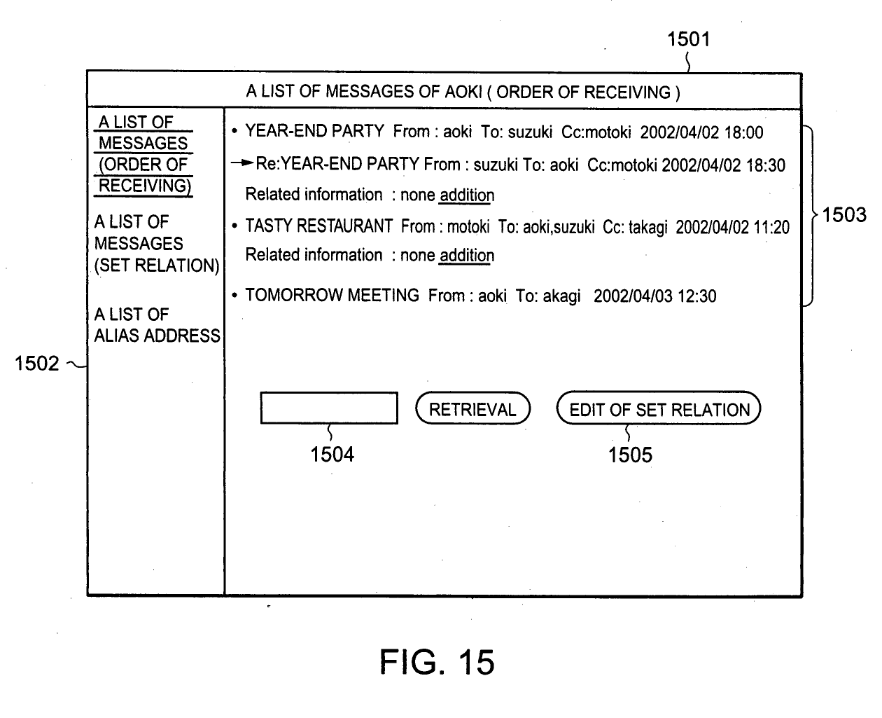

FIG. 15 shows one example of a screen of the message set display 209 in the case that the processing is forwarded to the message set display (step 1405). A title of contents displayed at present is located at the upper part 1501 of the screen, a group of selectable commands is located at the left part 1502 of the screen, a table of message sets related to the user is displayed at the center part 1503 of the screen, an input form 1504 for retrieving is located at the left and under part of the screen, and a button 1505 for shifting to a set relation edit screen to define a set relation for the displayed message set is arranged at the right and under part of the screen. Presentation of the retrieval function is not a necessary function of the present embodiment, but applied as one example of a utility function. Various known methods may be used for the retrieval method itself. In the present invention, a retrieval limit matched with the user's need can be presented. In this example of screen, retrieval is executed for a group of messages related to the user. In FIG. 15, by selecting a title of the displayed message, the user can inspect the contents of the displayed message.

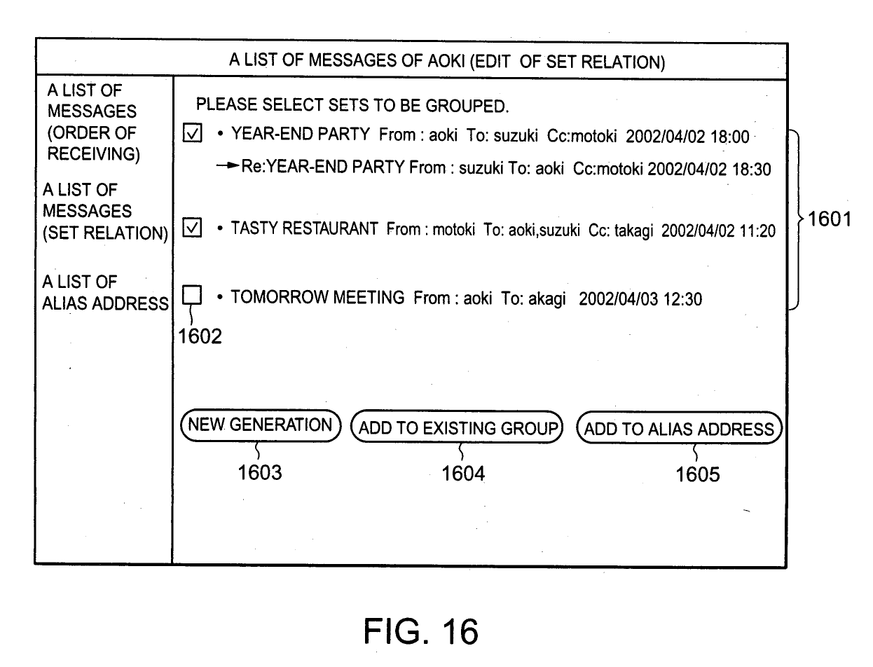

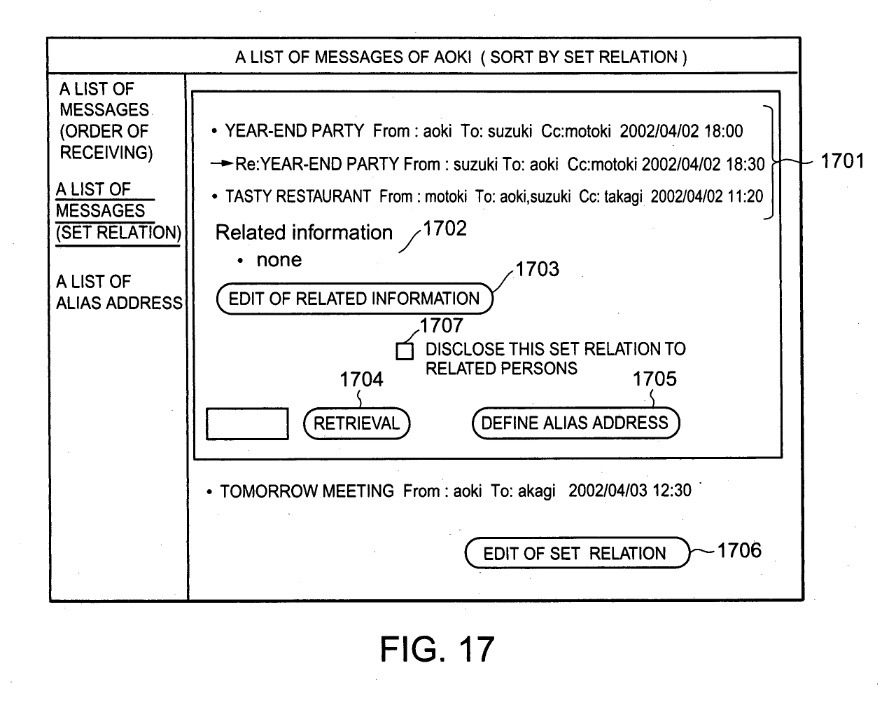

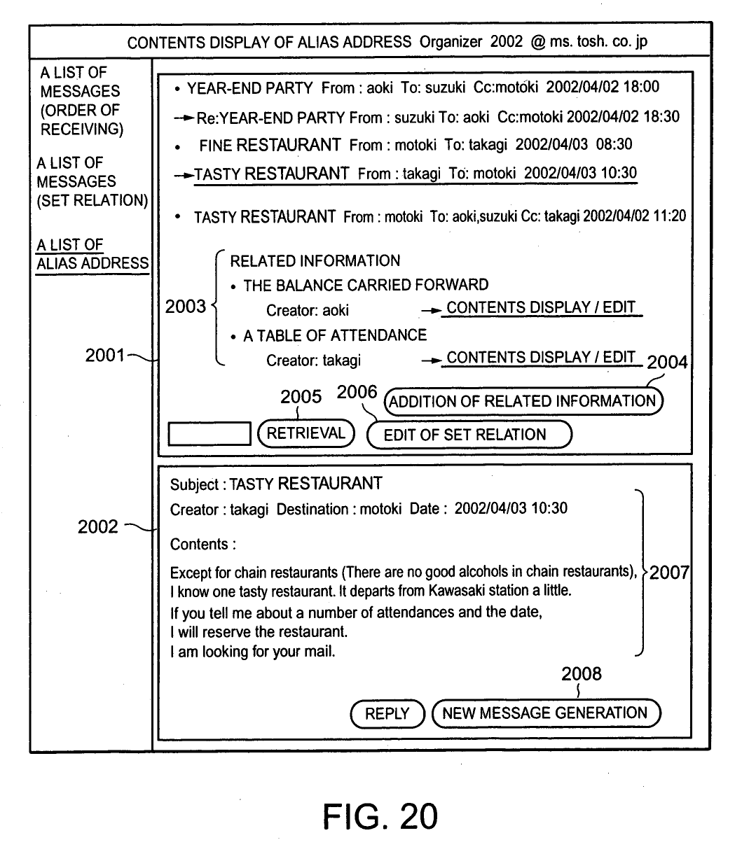

FIG. 16 shows one example of a screen for editing the set relation in the case that the processing is forwarded to set relation display (step 1407). Candidates of a message set to be included in a set relation are displayed at the center part 1601 of the screen. The candidates to be displayed change based on an original screen shifted to this edit screen. In the case of shifting from a screen of FIG. 15, all message sets related to the user are displayed. In the case of shifting from a screen of FIG. 17 (as later explained), a message set not included in the set relation is selected from all message sets related to the user and displayed. In the case of shifting from a screen of FIG. 20 (it is explained afterwards), message sets included in a set relation corresponding to the displayed alias address are displayed.

In FIG. 16, the user selects a message set to be related by a check box 1602. By selecting a new generation button 1603 of set relation, an addition button 1604 to existing group (set relation), or an addition button 1605 to a set relation corresponding to existing alias address, the user can select the set relation to which the selected message set is added. In the case of pushing the addition button 1604, a table of existing set relation is displayed, and the user selects one set relation to add the selected message set. Furthermore, in the case of pushing the addition button 1605, a table of alias address created by the user or registered is displayed, and the user selects one alias address to add the selected message set. In above-mentioned both cases, the right of inspection of added message set depends on the right of inspection of the set relation. Briefly, a user registered to an alias address and a user related to a set relation can inspect a message set even if these users did not directly send or receive a message belonging to the message set. The right of this inspection can be variously customized. For example, there may be an option that a creator of a set relation decides whether a message is inspected before registration to the alias address may be presented.

FIG. 17 shows an example of a screen of the message set display 209 on which message sets related to a user and grouped by a set relation are displayed. In the case of pushing the new generation button 1603 of the set relation in FIG. 16, this screen of FIG. 17 appears instead of the screen of FIG. 16. In the center part of the screen, message sets included in the set relation and other message sets are discriminately displayed. At a message set display part 1701 bind by a set relation, in addition to the message set, related information 1702 corresponding to the message set or the set relation is displayed. By pushing an edit button 1703 of related information, addition and edit of the related information can be executed. The addition and edit may be executed by using a means for uploading a file. By pushing a retrieval form 1704, retrieval is executed from messages corresponding to this set relation. By pushing a definition button 1705 of alias address, an alias address edit screen to define the alias address for this set relation appears instead of the screen of FIG. 17. Furthermore, by clicking a check box 1707 to disclose this set relation to users related to the set relation, this set relation is disclosed to each related user. As a result, each related user shares the set relation, and the set relation created by a particular user is displayed on a screen of another related user. At a display part of other message sets, an edit button 1706 of set relation is located. By pushing the edit button 1706, the edit screen of set relation of FIG. 16 appears instead of the screen of FIG. 17.

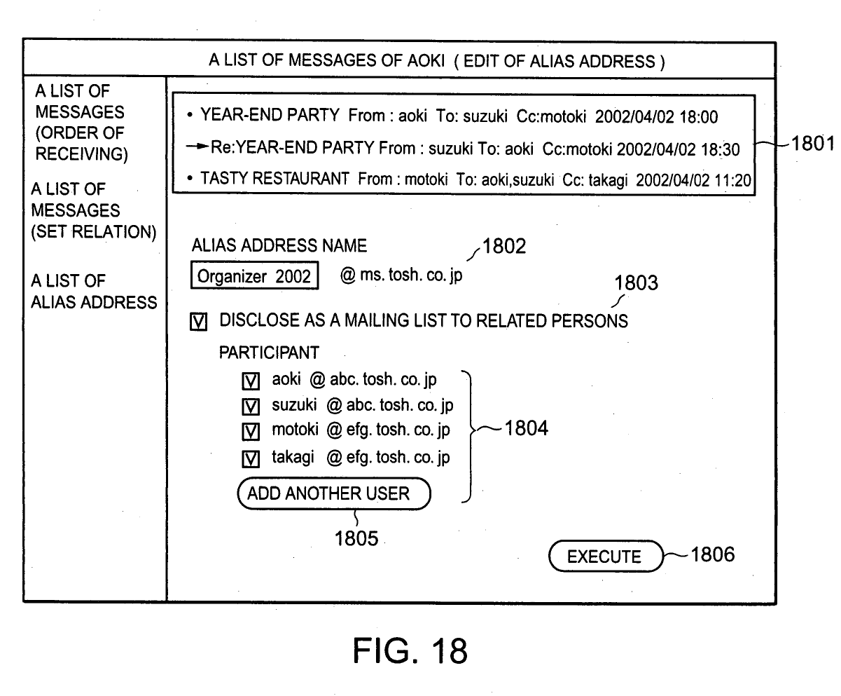

FIG. 18 shows one example of a screen of edit of alias address in the case that the processing is forwarded to the alias address display and edit (step 1409). As for the set relation selected before shifting to this screen, the alias address is assigned, and creation, addition and deletion of registered user is executed through the screen of FIG. 18. An input form 1802 of alias address name is a form to input an alias address name to be assigned to the displayed set relation 1801. In FIG. 18, “organizer2002@ms.tosh.co.jp” is input as alias address of this set relation. A message set including messages sent to this alias address belongs to this set relation. A check box 1803 is an icon to select whether the alias address is disclosed as a mailing-list. By disclosing the alias address, the right of inspection can be given to users as a registered user except for related persons. A check box 1804 of a user-list is an icon to add the registered user to the alias address. As a default, related users of the message set included in the set relation are displayed as a list. By pushing an addition button 1805 of another user, another user is added as the registered user to the alias address. By pushing an execution button 1806, above-mentioned contents are registered. If the input alias address overlaps with existing alias address, indication of the execution button 1806 pushed is cancelled and the screen of FIG. 18 does not change.

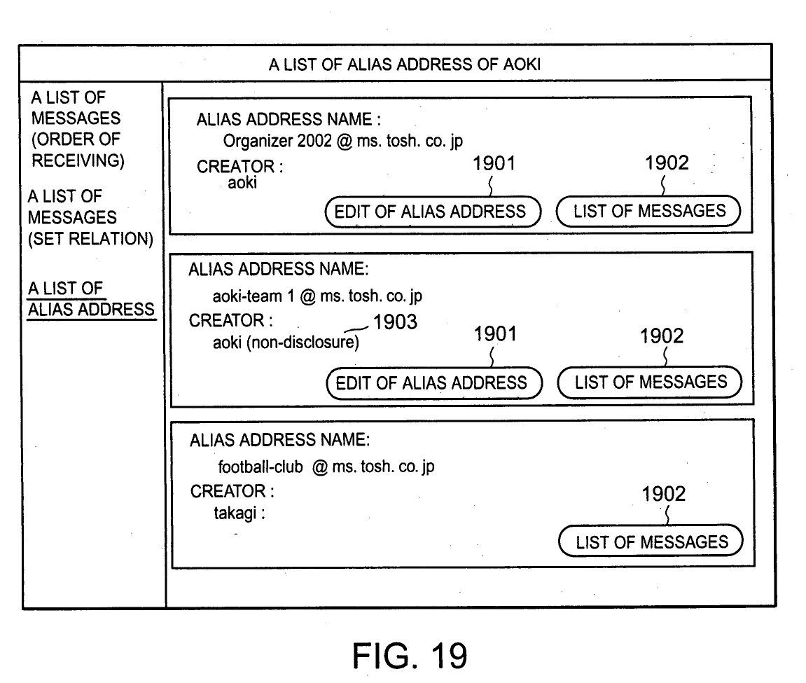

FIG. 19 shows one example of a screen of display of alias address in the case that the processing is forwarded to the alias address display and edit (step 1409). In this screen, a list of usable alias address for the user is displayed. An alias address name, creator name, and a list button 1902 of messages, are displayed for each alias address. An edit button 1901 of alias address is further displayed for the creator only. By pushing the edit button 1901, the screen of edit of alias address of FIG. 18 appears instead of the screen of FIG. 19. If a creator of alias address is the user himself and if the alias address is not disclosed as a mailing-list (In FIG. 18, the check box 1803 is “off”), a maker 1903 representing a purport is displayed. This marker is only displayed on a screen of the creator, and another user cannot know the existence of the alias address. However, the creator can send a message by using this alias address. As a result, the message is automatically added to the set relation already created.

FIG. 20 shows a screen of contents display of alias address. In this screen, contents of message sets included in a set relation corresponding to the alias address are displayed. A list of message sets included in the alias address is displayed at the upper part 2001 of the screen. The related information 2003 corresponding to the set relation is displayed at the upper part 2001 of the screen. By pushing an addition button 2004 of related information, new related information can be added to this set relation. As mentioned-above, the system may create a document related to the contents by using various prior methods and present the document as the related information. A retrieval form 2005 presents a retrieval function for the message included in this alias address as a limit. By pushing an edit button 2006 of set relation, the screen of edit of set relation (FIG. 16) of which object is the message sets included in this alias address appears instead of the screen of FIG. 20. By using this edit button 2006, a new set relation can be defined for a part of message sets included in the alias address. Furthermore, if new alias address is defined for this set relation, a part of messages included in original alias address can be transferred to the new alias address or shared by the new alias address. This aspect is very effective in communication in which a discussion shifted from an initial topic often occurs.

The contents 2007 of one of messages displayed at the upper part 2001 are displayed at the lower part 2002 of the screen. By pushing a button 2008 of reply or new message generation, a screen to create a reply message for the displayed message, or a screen to create a new message belonging to this set relation, appears instead of the screen of FIG. 20. The message created through the screen of FIG. 20 is sent to the message receiving unit 201 and processed in the same way as a normal message.

In FIG. 20, following two message sets are displayed in the upper part 2001 of the screen.

FINE RESTAURANT From:motoki To:takagi 2002/04/03 08:30

TASTY RESTAURANT From:takagi To:motoki 2002/04/03 10:30

These two message sets do not relate to “aoki” as the creator of the alias address shown in FIG. 20, but they are included in the set relation of the alias address. This reason will be explained. As shown in FIG. 9, these two message IDs are “m3, m4”, while the message set ID including these two message IDs is “t2”, and related users are “motoki, takagi”. Next, as shown in FIG. 11, in the case that “aoki” creates a set relation ID “r1”, two user names “motoki, takagi” are added as the registration user because these two user names “motoki, takagi” are included in the message 605 (FIG. 6E) sent to “aoki”. AS a result, each user “motoki, takagi” can know about the existence of the set relation ID “r1” and they can edit the set relation to add their message set “t2” in the same way of FIG. 16. On the screen of edit of set relation for each user “motoki, aoki”, two messages “m1, m2” as the message set “t2” are displayed. As shown in FIG. 16, if either of two users “motoki, aoki” selects the message set “t2” and pushes the addition button 1604 of existing group (set relation “r1”), the message set “t2” is added to the set relation “r1”. Accordingly, as shown in FIG. 20, two messages “m3, m4” belonging to the set relation “r1” corresponding to the alias address “organizer2002@ms.tosh.co.jp” are displayed on the screen of contents display of alias address for “aoki”.

Above-mentioned description explains the interaction between the system and the user and the internal processing.

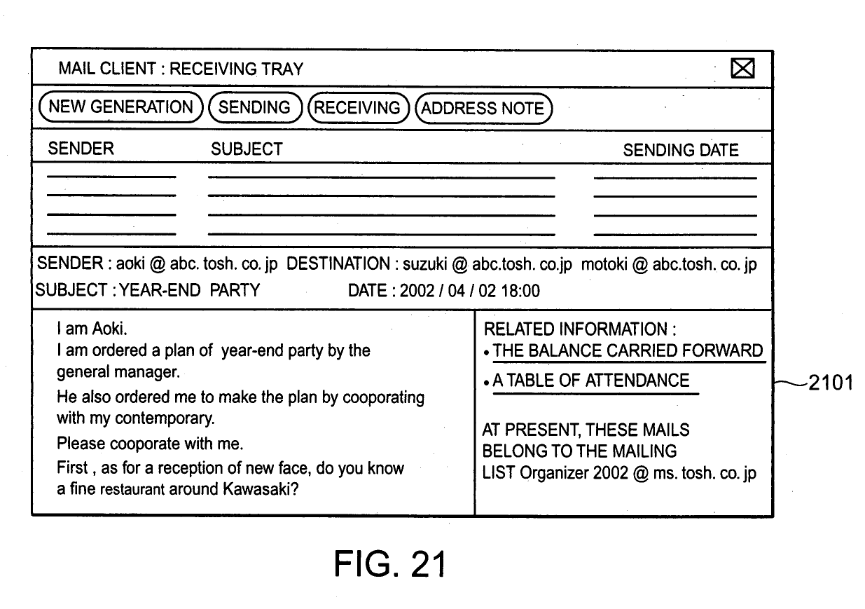

FIG. 21 shows an example of a screen of a general mailer to which a function to cooperate with the present system is loaded. The general mailer has a function to display information related to the received message. In this case, by inquiring of the present system, the mailer may have a function to display information related to a message set or a set relation to which the message to be displayed belongs. As shown in FIG. 21, information 2101 related to the message is additionally displayed. In the case of receiving a message, even if there is no related information at that time, this function is useful after passage of time. Concretely, when the user looks at mails of the past again, the user can clearly confirm which processing was executed for contents of the mail by the user himself or another person, which related information was added to the mail, and whether the mails are shared by the user and another person.

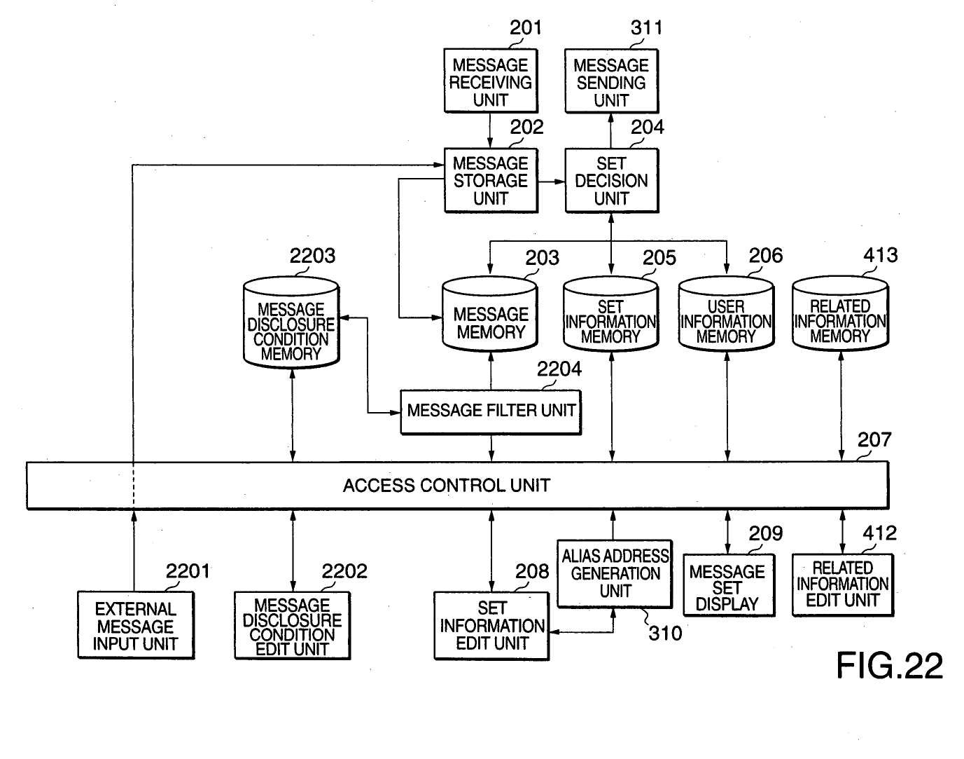

FIG. 22 is a block diagram of the message information sharing system according to a fourth embodiment of the present invention. In comparison with the block diagram of FIG. 4, an external message input unit 2201, a message disclosure condition edit unit 2202, a message disclosure condition memory 2203 and a message filter unit 2204 are newly included. Other units 201˜209, 310, 311, 412 and 413 are the same as those of FIG. 4. However, several units include additional function as follows. The message memory 203 further stores information (input person) representing a user who inputted an external message. The external message represents a message which was processed (sent and received) outside this message information sharing system. In the message memory 203, a message received by the message receiving unit 201 does not include the input person information. The set decision unit 204 adds a user identifier of the user who inputted the external message to the related users of a message set including the external message.

The external message input unit 2201 inputs the external message which is not received by the message receiving unit 201 in response to the user's indication. The external message is stored in the message memory 203 through the access control unit 207. For example, a message which is processed before this system is set up (introduced) or a message which is not received by the message receiving unit 201, is supplied to this system through the external message input unit 2201. The message disclosure condition edit unit 2202 registers a condition to disclose the message to another user except for the related users in the message disclosure condition memory 2203 in response to a related user's indication. Another user is, for example, a person who is not related to a message set including this message when this message is created, but obtains a right to access the message set because he/she is registered as a related user of an alias address of the message set.

The message disclosure condition memory unit 2203 stores the disclosure condition registered by the message disclosure condition edit unit 2202. The message filter unit 2204 filters (rewrites) contents of the message according to rewriting contents stored in the message disclosure condition memory 2203 when a user who is not the related user accesses the message from the message memory 203.

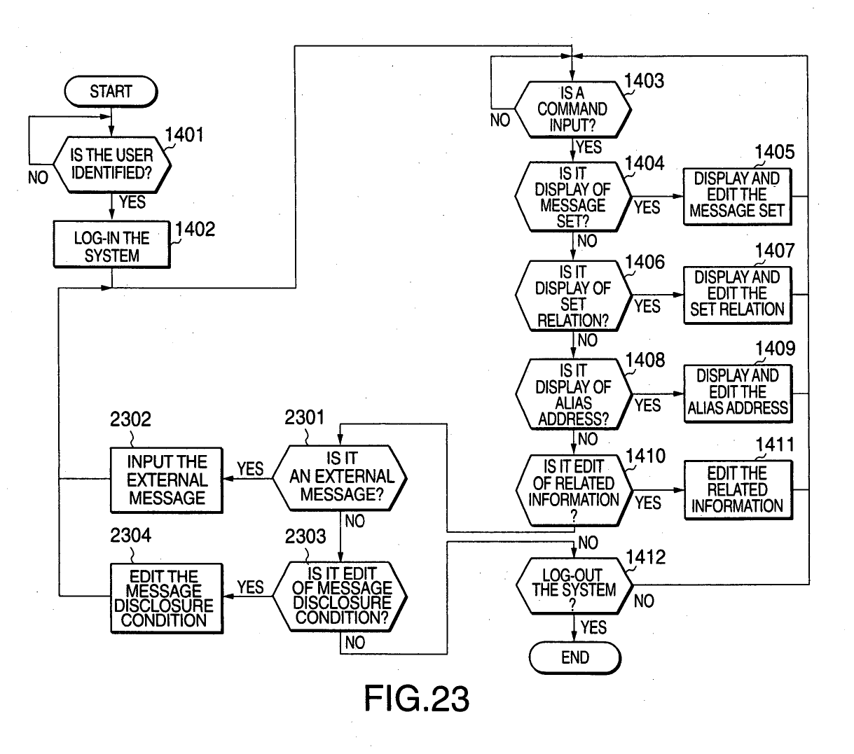

FIG. 23 is a flow chart of external message input and message disclosure condition edit according to the fourth embodiment of the present invention. Hereafter, interaction between the system and the user, and the internal processing, are explained by referring to FIG. 23. In FIG. 23, each step 1401˜1412 is the same as the flow chart of FIG. 14. Accordingly, explanation of these steps is omitted.

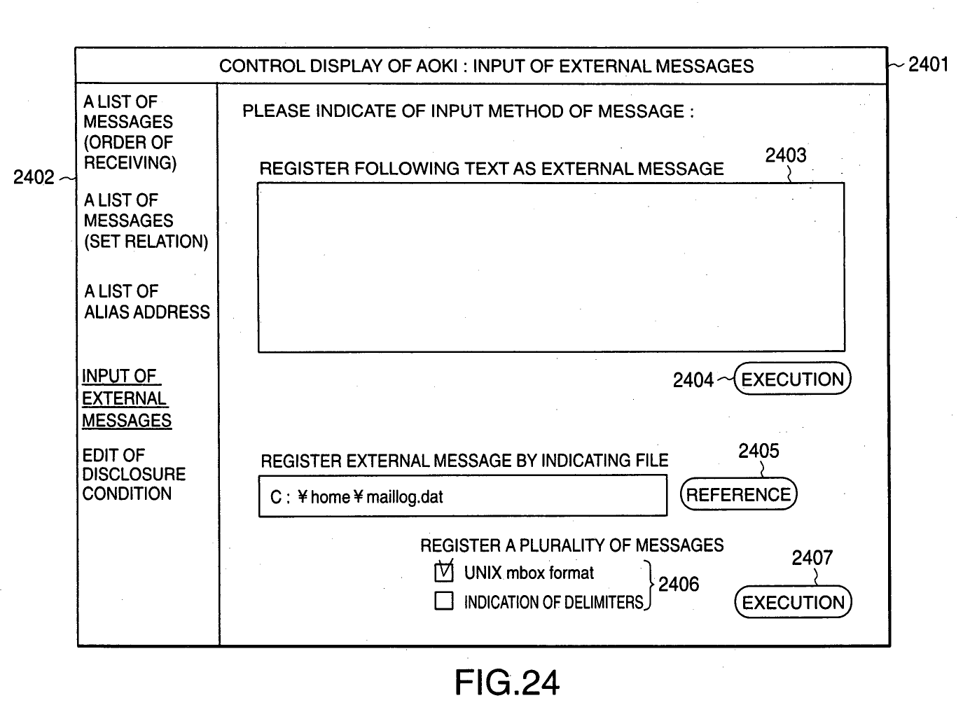

When input information is decided as an external message (2301), control of this system is forwarded to the input processing of the external message (2302). FIG. 24 is one example of an input screen of external messages displayed by the external message input unit 2201. On the upper part 2401 of the screen, contents of the selected command are displayed. On the left part 2402 of the screen, other selectable commands are displayed. On the central upper part of the screen, a text form 2403 to input contents of the message and a registration execution button 2404 are displayed. Furthermore, on the central lower part, a file name input form 2405 to indicate the external message as a file is displayed. A format of this file is indicated by a check box 2406. In the case of registering a plurality of messages at once, a format of file in which the plurality of messages is described is indicated by the check box 2406, and an execution button 2407 is selected. In FIG. 24, a UNIX mbox format often used for description of contents of a plurality of messages and a format in which each message is delimited by some character line are displayed as the check box 2406. Except for the text input form 2403 and the file name input form 2405, an external message may be input from a database storing this message by indicating the database.

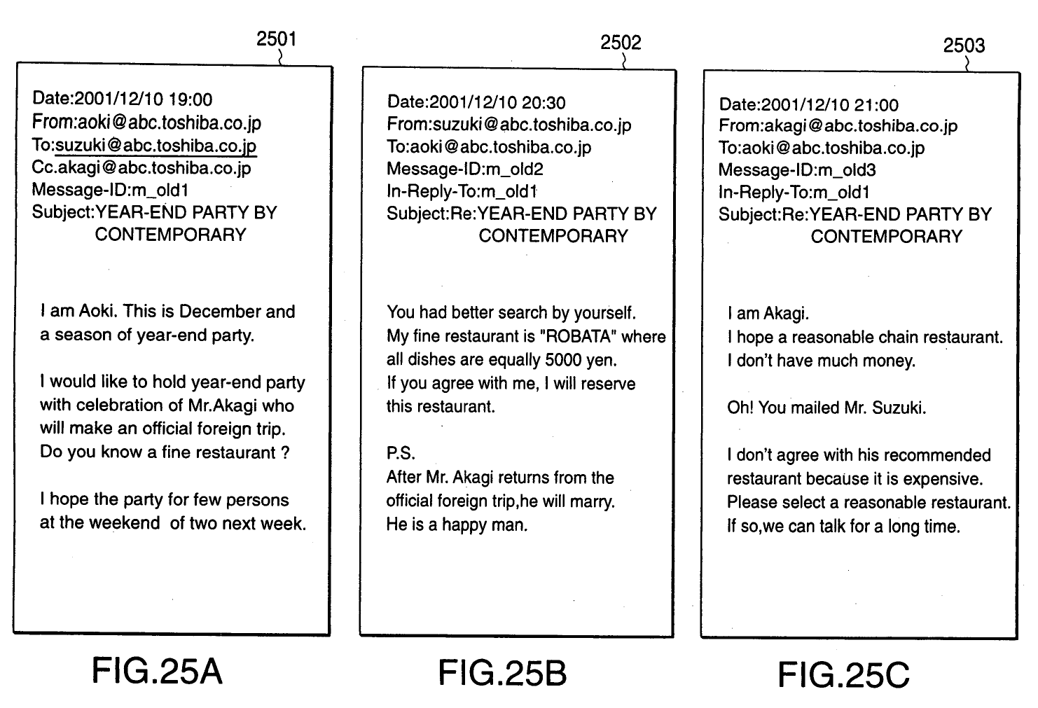

FIGS. 25A, 25B and 25C are examples of external messages. In comparison with FIGS. 6A-6F, “BCC:” header is not included in each external message. Accordingly, it is decided that these messages are not taken in this system. A user who can confirm “BCC:” header is a message creator only. In general, it is not easy for the user to decide whether the message is registered in the system by watching contents of the message. Usually, the user had better decide whether the message is registered by a creation date, for example, whether the message was created before this system is set up.

In FIG. 25A, the external message 2501 was created by a user “aoki” and sent to two users “suzuki” and “akagi”. In FIG. 25B, the external message 2502 was created by “suzuki” and sent to “aoki” as a reply of the message 2501. In FIG. 25C, the external message 2503 was created by “akagi” and sent to “aoki” as a reply of the message 2501.

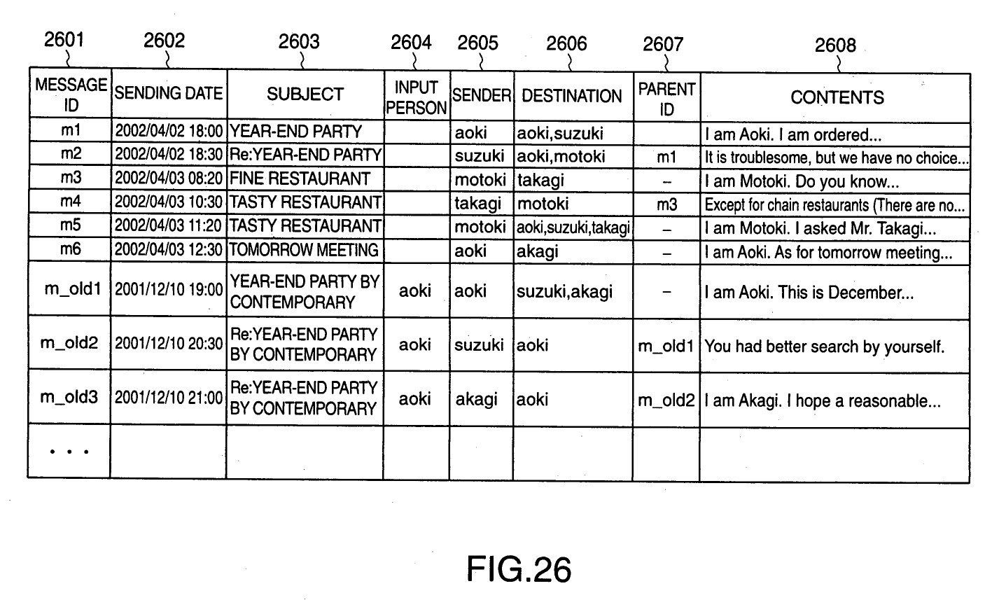

FIG. 26 is one example of a data structure of the message memory 203 storing the external message. The data structure includes a message ID 2601, a sending date 2602, a subject 2603, an input person 2604, a sender 2605, a destination 2606, a parent ID 2607 and contents 2608. The message ID 2601 is a peculiar identifier to discriminate the message, and “Message-ID” in the message may be used as it is. The parent ID 2607 represents a reply relationship between messages, and one or a plurality of parent IDs can be written. “In-Reply-To” header in the message may be used as the parent ID. Furthermore, by deciding a relationship between the message and another message using a prior method, the related message previously processed may be recorded as the parent ID. For example, by referring to sentence contents surrounded by a quotation mark (“>”, “|”) in a message, a relationship between the message and another message sent in the past is estimated. Furthermore, by calculating a similarity of the sending time and the destination, or by calculating a similarity of sentences based on statistical quantity of each word in the text, a relationship between the message and another message is estimated. In FIGS. 25A, 25B and 25C, “Message-ID” header is a known message identifier determined by “RFC822”. Assumption that such identifier exists is not unnatural.

In FIG. 26, as for the external messages of which message ID is m_old1, m_old2 and m_old3, a user name (user identifier) of the user who inputted the external message is recorded as the input person (“aoki”). Even if the user who inputted the external message is neither the sender nor the destination, this user is registered as an input person related to the external message. Because this user already obtains the external message and it is meaningless that contents of this external message are concealed from this user.

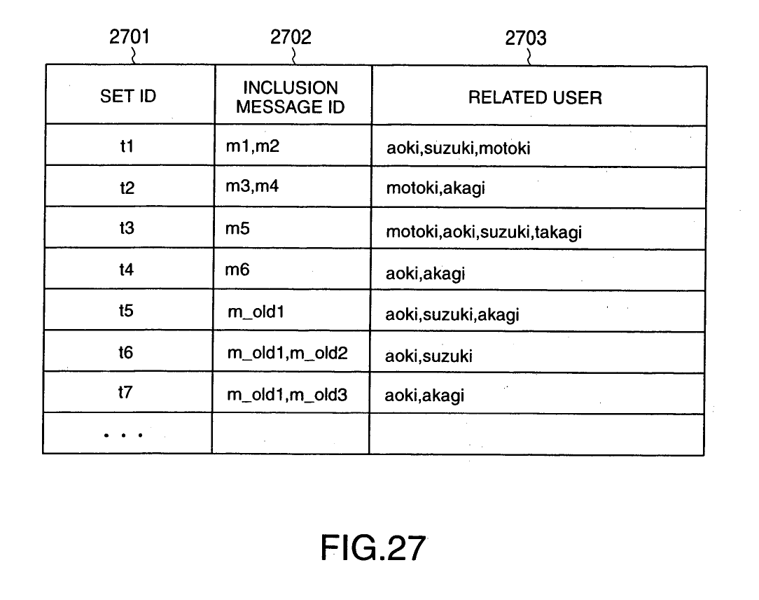

FIG. 27 is one example of a data structure of the set information memory 205. The data structure is basically the same as that of FIG. 9. In FIG. 27, a set ID 2701, a message ID 2702 included in each set, and related users of the set, are correspondingly recorded. Especially, as for each external message m_old1, m_old2 and m_old3, set IDs t5, t6 and t7 are assigned by the reply relationship of each external message.

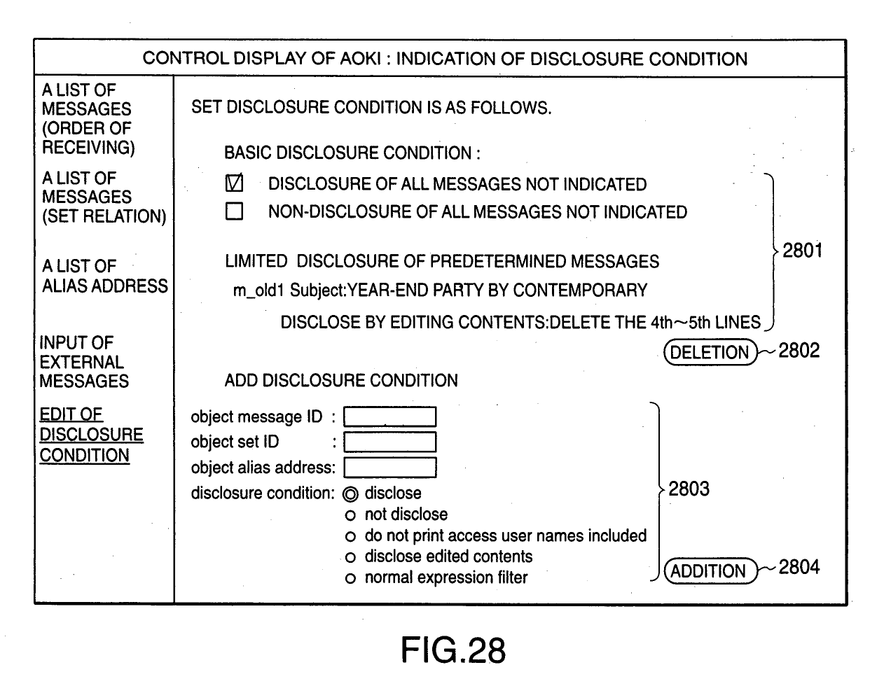

Next, in FIG. 23, when an input of message disclosure condition is indicated (2303), control of this system is forwarded to an edit processing of message disclosure condition (2304). FIG. 28 is one example of a screen of the message disclosure condition edit unit 2202. As shown in FIG. 28, a disclosure condition 2801 already registered and a deletion button 2802 to delete each disclosure condition, are located on the screen. In this example, following two conditions are shown as a basic item for the message related to the user.

Disclosure of all messages

Non-disclosure of all messages

However, another item such as “Disclosure of messages not including the name of a person and non-disclosure of other messages” may be located.

On the lower part of the screen, a form 2803 to input the disclosure condition by unit of a message, a set and a set relation (alias address) is located. In FIG. 28, following five disclosure conditions are shown.

Disclose

Not disclose

Do not print access user names included in a message (The access user names are obtained by referring to the user information memory 206)

Disclose the edited contents of the message

Typical replacement of characters in the message (Indication of normal expression pattern)

By setting this condition and pushing an addition button 2804, registration information is recorded in the message disclosure condition memory 2203. The recorded condition is additionally displayed on the upper part 2801 of the screen. In FIG. 28, the deletion button 2802 and the addition button 2804 are only located. However, a button to edit the registered information may be located. Furthermore, a button to indicate a user on which the disclosure condition is affected may be located.

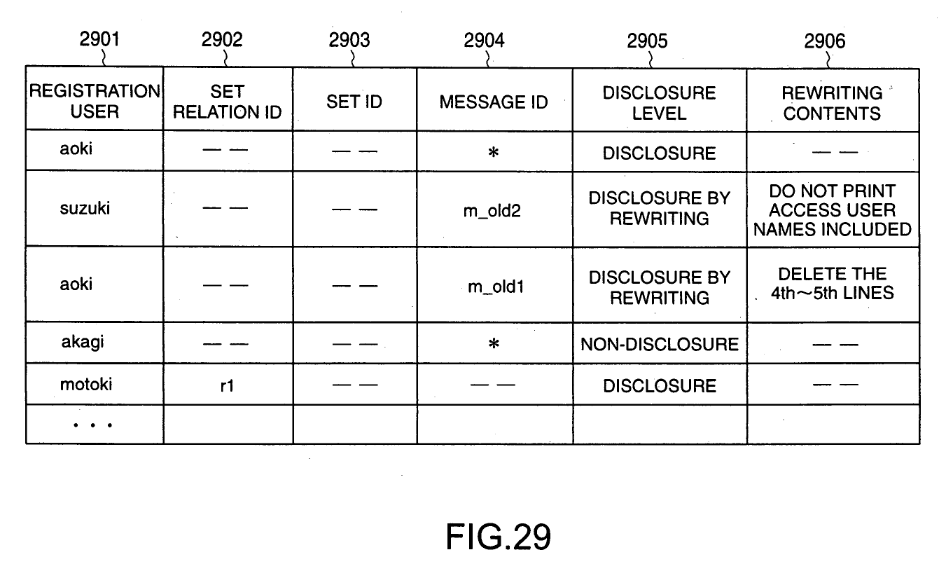

FIG. 29 is one example of a data structure of the message disclosure condition memory 2203. The data structure includes a registration user 2901, a set relation ID 2902, a set ID 2903, a message ID 2904, a disclosure level 2905, and a rewriting contents 2906. In the set relation ID 2902, the set ID 2903 and the message ID 2904, a plurality of IDs or a sign “* ” representing all IDs can be recorded. In the disclosure level 2905, “disclosure”, “nondisclosure” and “disclosure by rewriting”, can be selectively recorded. In the rewriting contents 2906, for example, difference information between original contents and rewritten contents is recorded.

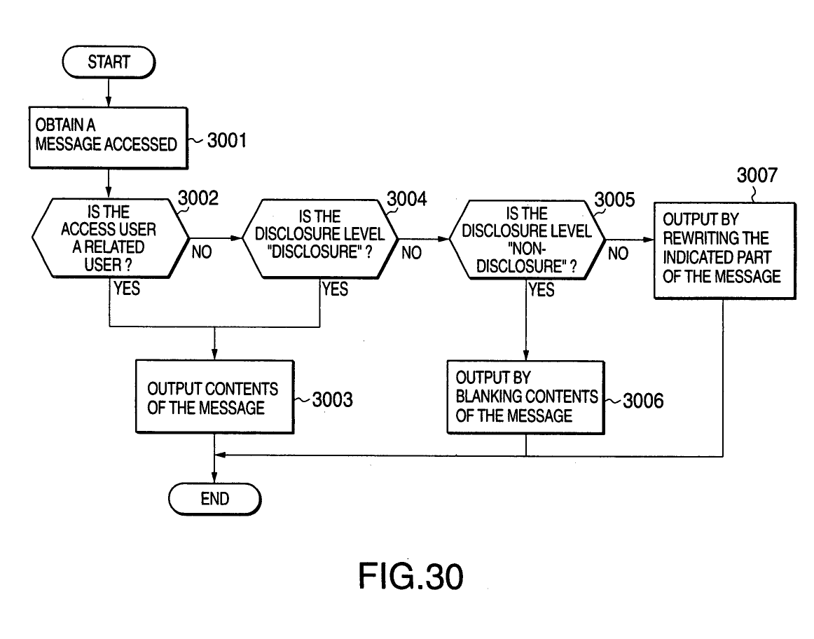

The message disclosure condition is used by the message filter unit 2204 in the case of accessing the message stored in the message memory 203 through the access control unit 207. FIG. 30 is a flow chart of processing of the message filter unit 2204. Hereafter, processing of the message filter unit 2204 is explained by referring to FIG. 30. When a user indicates access of a message through the access control unit 207, the message is obtained from the message memory 203 (3001). Next, it is decided whether the user is a related user of this message by referring to the set information memory 205 (3002). If the user is the related user, contents of the message are output without filter processing (303). If the user is not the related user, i.e., if the user did not relate to the message when the message was sent and received in the past, the message filter unit 2204 retrieves the disclosure level of a message ID of this message from the message disclosure condition memory 2203. If the disclosure level of the message ID is “disclosure” (3004), the contents of this message are output without filter processing (3003). If the disclosure level of the message ID is “non-disclosure” (3005), the contents of this message is output as a format of which contents are not understandable (3006). For example, the contents are blanked in the message or a message representing “non-disclosure” is informed to the user as a format of some error or an exception. If the disclosure level of the message ID is “disclosure by rewriting”, the contents of this message are output by rewriting the indicated part of this message (3007).

For example, a decision standard to select one from “disclosure”, “non-disclosure” and “disclosure by rewriting”, is represented as follows.

Disclosure: all related users of the message (or a message set to which the message belongs) indicate “disclosure”.

Non-disclosure: At least one of all related users of the message (or a message set to which the message belongs) indicates “non-disclosure”.

Disclosure by rewriting: At least one of all related users of the message (or a message set to which the message belongs) indicates “disclosure by rewriting”.

In the case of rewriting contents of the message, if a plurality of conditions “disclosure by rewriting” exists for the same message ID and if a part to be rewritten as “rewriting contents” of each condition overlaps, one condition is preferentially selected from the plurality of conditions. For example, one condition to rewrite the largest number of characters in the message is selected. Furthermore, if contents of the message quotes contents of parent message by a quotation mark, the message filter unit 2204 decides whether the disclosure level of the quoted part of the parent message is “disclosure”, “non-disclosure” or “disclosure by rewriting” by referring to the message disclosure condition memory 2203. In this case, the message filter unit 2204 outputs the contents of the message on which the disclosure level of the quoted part of the parent message affects.

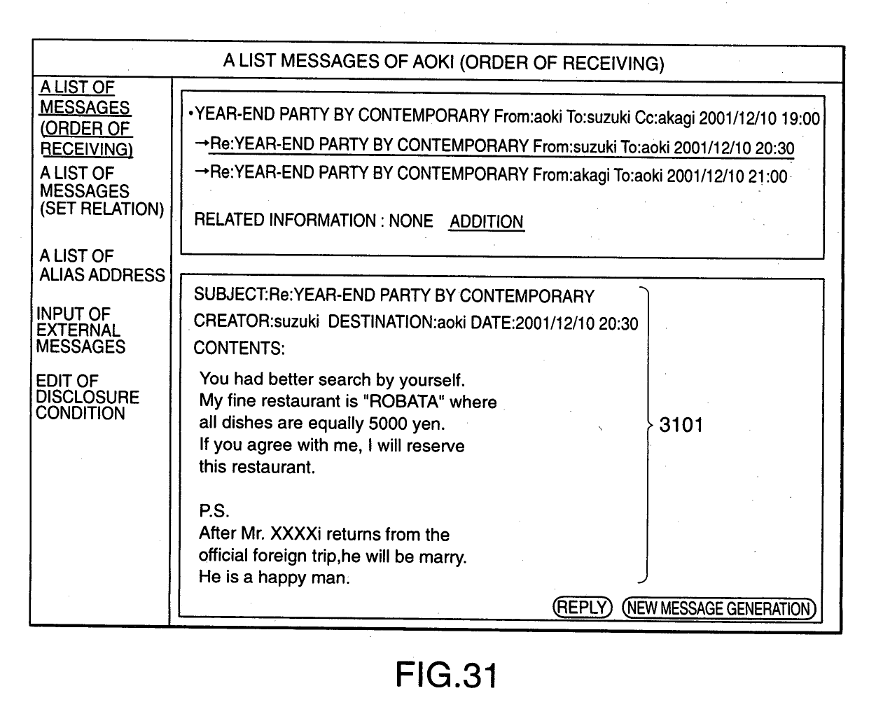

FIG. 31 is one example of a screen on which the message 3101 partially rewritten by the message filter unit 2204 is displayed. As for the selected message m_old2, as shown in FIG. 29, the disclosure level “disclosure by rewriting” and the rewriting contents “do not print access user names included in the message” are registered. For example, when the user “akagi” accesses the message m_old2, the user “akagi” is not a related user of the message set t6 to which the message m_old2 belongs as shown in FIG. 27. Accordingly, an access user name included in the message m_old2 is not printed (concealed) by “XXXX” as shown in FIG. 31. This is the simplest method for concealing characters in the message. However, by using a known method for analyzing a sentence structure, all sentences including characters to be concealed may be deleted or rewritten. By outputting this rewritten message, information concealment can be naturally executed.

As mentioned-above, in the present invention, in the case of electronic communication, i.e., discussion using the electronic mail, even if a mailing-list is not explicitly used, a participant of the discussion can group the mails by relational unit and look a list of grouped mails. Furthermore, in the case of creating a mailing-list, the participant can completely include contents of the mails given and taken in the past. As a result, a decision whether the mailing-list is used is not necessary, a user no longer has to worry that the decision is erroneous, a discussion of small scale is easy for the user to begin, and the discussion on a small scale can be easily developed to a discussion of middle scale or large scale. Furthermore, the user can easily understand the contents of mails of the past and utilize contents of the discussion again. Briefly, efficiency and utility of the communication for the user greatly improve.

For embodiments of the present invention, the processing of the present invention can be accomplished by a computer-executable program, and this program can be realized in a computer-readable memory device.

In embodiments of the present invention, the memory device, such as a magnetic disk, a floppy disk, a hard disk, an optical disk (CD-ROM, CD-R, DVD, and so on), an optical magnetic disk (MD, and so on) can be used to store instructions for causing a processor or a computer to perform the processes described above.

Furthermore, based on an indication of the program installed from the memory device to the computer, OS (operation system) operating on the computer, or MW (middle ware software), such as database management software or network, may execute one part of each processing to realize the embodiments.

Furthermore, the memory device is not limited to a device independent from the computer. By downloading a program transmitted through a LAN or the Internet, a memory device in which the program is stored is included. Furthermore, the memory device is not limited to one. In the case that the processing of the embodiments is executed by a plurality of memory devices, a plurality of memory devices may be included in the memory device. The component of the device may be arbitrarily composed.

In embodiments of the present invention, the computer executes each processing stage of the embodiments according to the program stored in the memory device. The computer may be one apparatus such as a personal computer or a system in which a plurality of processing apparatuses are connected through the network. Furthermore, in the present invention, the computer is not limited to the personal computer. Those skilled in the art will appreciate that a computer includes a processing unit in an information processor, a microcomputer, and so on. In short, the equipment and the apparatus that can execute the functions in embodiments of the present invention using the program are generally called the computer.

Other embodiments of the invention will be apparent to those skilled in the art from consideration of the specification and practice of the invention disclosed herein. It is intended that the specification and examples be considered as exemplary only, with the true scope and spirit of the invention being indicated by the following claims.

What is claimed is:

1. A message information sharing apparatus, comprising:
a message receiving unit configured to receive a message from a user as a received message;
a message memory configured to store the received message and a plurality of other messages as stored messages;
a set decision unit configured to decide whether the received message is related to at least one of the other messages stored in said message memory;
a set information memory configured to store a first message set including the received message and the at least one of the other messages if said set decision unit decides that the received message is related to the at least one of the other messages; and
a set information edit unit configured to edit a set relation among a plurality of message sets and the first message set in response to the user's indication;
wherein said set information memory stores the set relation edited by said set information edit unit.

2. The message information sharing apparatus according to claim 1,
wherein said message memory correspondingly stores a message identifier, a sending date, a sender name, a destination, a parent message identifier, and contents for each of the stored messages.

3. The message information sharing apparatus according to claim 2,
if the received message includes the parent message identifier,
wherein said set decision unit decides that the received message belongs to the first message set of the stored message corresponding to the parent message identifier.

4. The message information sharing apparatus according to claim 3,
if the received message does not include the parent message identifier,
wherein said set decision unit generates a new message set to which the received message belongs.

5. The message information sharing apparatus according to claim 4,
wherein said set information memory stores message set information for at least the first message set including a set identifier of the first message set, the message identifiers of those of the stored messages belonging to the first message set, and related users as the sender name and the destination of those of the stored messages belonging to the first message set.

6. The message information sharing apparatus according to claim 5,
when the user indicates a desired relationship among any of the message sets and the first message set in the message set information,
wherein said set information edit unit generates a set relation identifier of the set relation to which of the message sets are related to the first message set.

7. The message information sharing apparatus according to claim 6,
wherein said set information memory stores set relation information including the set relation identifier, the set identifiers of those of the message sets being related to the first message set, and a user identifier of the user.

8. The message information sharing apparatus according to claim 7, further comprising an alias address generation unit configured to generate an alias address corresponding to the set relation in response to a user's indication.

9. The message information sharing apparatus according to claim 8,
wherein said set information memory stores alias address information including the alias address, the set relation identifier, the user identifier of the user, and registered users as the related users of the message sets belonging to the set relation.

10. The message information sharing apparatus according to claim 9,
when said message receiving unit receives a further message including the alias address as the destination,
wherein said set decision unit adds at least one of the message sets to which the further message belongs to the set relation corresponding to the alias address.

11. The message information sharing apparatus according to claim 10,
further comprising a message sending unit configured to send an outbound message,
wherein said set decision unit retrieves the registered users corresponding to the alias address from the alias address information, and
said message sending unit sends the outbound message using the alias address to the registered users.

12. The message information sharing apparatus according to claim 7,
further comprising a related information edit unit configured to input and edit related information corresponding to the set relation in response to a user's operation.

13. The message information sharing apparatus according to claim 12,
further comprising a related information memory configured to store the related information including a related information identifier, the set relation identifier of the set relation corresponding to the related information, a creation date of the related information, the user identifier of the user, and contents of the related information.

14. The message information sharing apparatus according to claim 1,
further comprising a user information memory configured to store user information including the user identifier, an account as the user name, a mail address, and a password of the user.

15. The message information sharing apparatus according to claim 14,
further comprising an access control unit configured to decide whether to grant access to information stored in said message memory and said set information memory by referring to the user information stored in said user information memory.

16. The message information sharing apparatus according to claim 15,
if said access control unit decides to grant access to the information stored in said message memory and said set information memory,
wherein said set information edit unit permits editing of the set relation among the plurality of message sets and the first message set.

17. The message information sharing apparatus according to claim 11,
further comprising a display device selectively displaying a table of the message sets related to the user and the first message set, an edit screen of the set relation, an edit screen of the alias address, and an edit screen of the related information in response to a command input.

18. The message information sharing apparatus according to claim 17,
when said display device displays the edit screen of the alias address,
wherein said set information edit unit determines whether the message including the alias address is sent to the registered users corresponding to the alias address, and selects a participant whom the message including the alias address is sent from the registered users in response to the user's indication.

19. The message information sharing apparatus according to claim 15,
further comprising an external message input unit configured to input an external message in response to a user's indication, the external message being processed outside the message information sharing apparatus and not received by said message receiving unit.

20. The message information sharing apparatus according to claim 19,
wherein said message memory stores information of the external message including a message identifier, a sending date, a user identifier of the user who indicated an input of the external message, a sender name, a destination, a parent message identifier, and contents of the external message.

21. The message information sharing apparatus according to claim 20,
wherein said set decision unit decides whether the external message is related to another external message by referring to the parent message identifier of each external message, and defines a message set including the external message and another external message if the external message is decided to be related to another external message.

22. The message information sharing apparatus according to claim 21,
wherein said set decision unit defines the user identifier of the user who indicated an input of the external message, the sender name and the destination of each external message as related users of the message set.

23. The message information sharing apparatus according to claim 22,
wherein said set information memory stores a set identifier of the message set, the message identifier of each external message included in the message set, and each user identifier of the related users.

24. The message information sharing apparatus according to claim 15,
further comprising a message disclosure condition edit unit configured to register a condition to disclose each message to a user except for the related users of the message set in response to a related user's indication.

25. The message information sharing apparatus according to claim 24, further comprising a message disclosure condition memory configured to store a user identifier of the related user who inputted the condition, the message identifier of the message of the related user, a disclosure level representing one of disclosure, non-disclosure and disclosure by rewriting, and rewriting contents for the disclosure by rewriting.

26. The message information sharing apparatus according to claim 25,
when a user except for the related users accesses a message stored in said message memory,
wherein said access control unit controls an output of the message by referring to the disclosure level corresponding to a message identifier of the message stored in said message disclosure condition memory.

27. The message information sharing apparatus according to claim 26,
further comprising a message filter unit configured to rewrite contents of the message by referring to rewriting contents corresponding to the message identifier of the message stored in said message disclosure condition memory, and to supply the message including the rewritten contents to said access control unit.

28. The message information sharing apparatus according to claim 27,
if the contents of the message is included in another message stored in said message memory, and when the user accesses another message,
wherein said message filter unit rewrites the contents of the message included in another message by referring to the rewriting contents, and supplies another message including the rewritten contents to said access control unit.

29. A method for sharing message information, comprising:
receiving a message from a user;
storing the received message and a plurality of other messages as stored messages in a message memory;
deciding whether the received message is related to at least one of the other messages;
storing a first message set including the received message and the at least one of the other messages in a set information memory if the received message is related to the at least one of the other messages;
editing a set relation among a plurality of message sets and the first message set in response to the user's indication; and
storing the set relation edited in the set information memory.

30. A computer program product, comprising:
a computer readable program code embodied in said product for causing a computer to share message information, said computer readable program code comprising:
a first program code to receive a message from a user;
a second program code to store the received message and a plurality of other messages as stored messages in a message memory;
a third program code to decide whether the received message is related to at least one of the other messages;
a fourth program code to store a first message set including the received message and the at least one of the other messages in a set information memory if the received message is related to the at least one of the other messages;
a fifth program code to edit a set relation among a plurality of message sets and the first message set in response to the user's indication; and
a sixth program code to store the set relation edited in the set information memory.
